(19) United States
(12) Patent Application Publication
(10) Pub. No.: US 2017/0362811 A1
(43) Pub. Date: Dec. 21, 2017

(54) Modular Construction System

(71) Applicant: Charles King, JR., Bethel, CT (US)

(72) Inventor: Charles King, JR., Bethel, CT (US)

(21) Appl. No.: 15/185,174

(22) Filed: Jun. 17, 2016

(51) Int. Cl. E04B 1/19; A63H 33/10; F16B 12/40; F16B 12/10; E04B 1/344; E04B 1/41

(52) U.S. Cl. CPC E04B 1/1912; E04B 1/3441; E04B 1/40; F16B 12/40; F16B 12/10; A63H 33/108; E04B 2001/1918; E04B 2001/1933; E04B 2001/199; F16B 2012/103; E04B 2001/1957

(57) ABSTRACT

A modular construction system comprising: a main connector having a body and an integrally formed rod, the rod having a rod tubular body, a rod insertion end, and a rod hollow chamber traversing the rod from the rod tubular body through the rod insertion end, and wherein the rod is radially disposed about the body; a plurality of main bars, the main bars having a first receiving end, a main bar tubular body, a second receiving end, a main bar hollow chamber traversing the main bar from the first receiving end through the main bar tubular body to the second receiving end, at least three main bar longitudinal sides, a plurality of apertures on the main bar longitudinal sides, and at least three main bar grooves between adjacent main bar longitudinal sides, the main bar grooves being parallel with the main bar tubular body and the main bar hollow chamber.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of the Invention

The present invention generally relates to modular construction systems, where the different components may be assembled into various structures.

### 2. Background

Modular construction systems are used for many different fields including furniture, commercial and residential structures, and the toy industry. There is a need for a modular construction system that is economical, practical, easily and quickly assembled and disassembled, easily transported and lightweight yet strong. Preferably, the components of a modular construction system should require a minimal amount of labor to assemble and disassemble structures without the requirement of the use of tools. Furthermore, the assembled structures should be capable either being utilized temporarily or permanently.

The present invention advantageously is dimensionally scalable to accommodate different applications, does not require tools for assembly, is quickly assembled and disassembled, is easy to change configurations, is lightweight yet strong, and is highly transportable. The components of the present invention may be fabricated from a variety of different materials, including but not limited to, plastics, metals, wood, fiberglass, glass, fabrics, composites, ceramics, and combinations thereof.

### BRIEF SUMMARY OF THE INVENTION

In one embodiment of the invention, a modular construction system is provided, the modular construction system comprising: a main connector having a body and an integrally formed rod, the rod having a rod tubular body, a rod insertion end, and a rod hollow chamber traversing the rod from the rod tubular body through the rod insertion end, and wherein the rod is radially disposed about the body; a plurality of main bars, each of the main bars having a first receiving end, a main bar tubular body, a second receiving end, a main bar hollow chamber traversing the main bar from the first receiving end through the main bar tubular body to the second receiving end, at least three main bar longitudinal sides, a plurality of apertures on the main bar longitudinal sides, and at least three main bar grooves between adjacent main bar longitudinal sides, and the main bar grooves being parallel with the main bar tubular body and the main bar hollow chamber; and, wherein the rod insertion end being adapted to be fitted into the receiving ends.

In another embodiment of the invention, a modular construction system is provided, the modular construction system comprising: a main connector having a body and a hole, wherein the hole is radially disposed about the body; a rod having a rod main connector end, a rod tubular body, a rod insertion end, and a rod hollow chamber traversing the rod from the rod main connector end through the rod tubular body and through the rod insertion end, and wherein the rod main connector end is releasably engaged to the hole; and, a plurality of main bars, each of the main bars having a first receiving end, a main bar tubular body, a second receiving end, a main bar hollow chamber traversing the main bar from the first receiving end through the main bar tubular body to the second receiving end, at least three main bar longitudinal sides, a plurality of apertures on the main bar longitudinal sides, and at least three main bar grooves between adjacent main bar longitudinal sides, and the main bar grooves being parallel with the main bar tubular body and the main bar hollow chamber; and, wherein the rod insertion end being adapted to be fitted into the receiving ends.

### BRIEF DESCRIPTION OF THE SEVERAL VIEWS OF THE DRAWING

FIGS. 1A-1H are perspective views of embodiments of the main connector and the rod. FIG. 1A is a perspective view of the main connector integrally formed with rods. FIG. 1B is a perspective view of the main connector. FIG. 1C is a partially exploded perspective view of an embodiment of the main connector with one rod assembled. FIG. 1D is a perspective view of the rod. FIG. 1E is a top view and a cross-section of the rod. FIG. 1F is a perspective view of another embodiment of the main connector assembled with the rod. FIG. 1G is a perspective view of another embodiment of the main connector. FIG. 1H is a perspective view of another embodiment of the rod.

FIGS. 2A-2C are perspective views of embodiments of the main bar. FIG. 2B are perspective and end views of an embodiment of the main bar. FIG. 2C is a perspective view of an embodiment of the main bar assembled with rods and the main connector.

FIG. 3 is an exploded view of an embodiment of the main connector block, rod, reinforcement rod, and main bar.

FIGS. 4A-4B are perspective views of embodiments of the inside bar hanger connector. FIG. 4B is a perspective view of an embodiment of the inside bar hanger connector assembled with main connectors, rods and main bars.

FIGS. 5A-5B are perspective views of embodiments of the main bar splice. FIG. 5B is a perspective view of the main bar splice assembled with the main bar.

FIG. 6 is a perspective view of an embodiment of the ball and socket connector.

FIG. 7 is a perspective view of an embodiment of the flexible angle corner connector.

FIGS. 8A-8B are perspective views of embodiments of the outside angle bar hanger connector. FIG. 8B is a perspective view of the outside angle bar hanger connector assembled with main connectors, rods, and main bars.

FIGS. 9A-9B are perspective views of embodiments of the angled low profile bar. FIG. 9B is a partially exploded perspective view of the angled low profile bar assembled with main connectors and rods.

FIGS. 10A-10B are perspective views of embodiments of the flat low profile bar. FIG. 10B is a partially exploded perspective view of the flat low profile bar assembled with main connectors and rods.

FIGS. 11A-11D are perspective views of embodiments of the cross bar and the cross bar connector. FIG. 11A is a perspective view of the cross bar. FIG. 11B is a perspective view of the cross bar connector. FIG. 11C is a perspective view of the cross bar assembled with the cross bar connector. FIG. 11D is a perspective view of the cross bar assembled with cross bar connectors, main bars, main connectors, and rods.

FIG. 12 is a perspective view of an embodiment of the panel.

FIGS. 13A-13D are perspective views of embodiments of the inside snap spline. FIGS. 13C and 13D are perspective views of the inside snap spline assembled with main bars and panels.

FIGS. 14A-14B are perspective views of embodiments of the outside snap spline. FIG. 14 B is a perspective view of the outside snap spline assembled with main bars and panels.

FIGS. 14A-14B are perspective views of embodiments of the outside snap spline. FIG. 14 B is a perspective view of the outside snap spline assembled with main bars and panels.

FIGS. 15A-15B are perspective views of embodiments of the corner brace bar. FIG. 15B is a perspective view of the corner brace bar assembled with main bars, rods, and the main connector.

FIG. 16 is a perspective view of an assembled embodiment present invention.

### DETAILED DESCRIPTION OF THE INVENTION

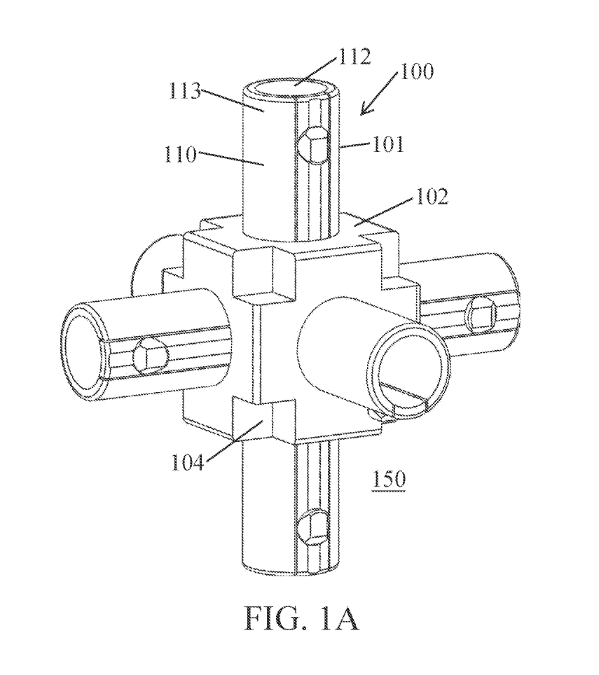

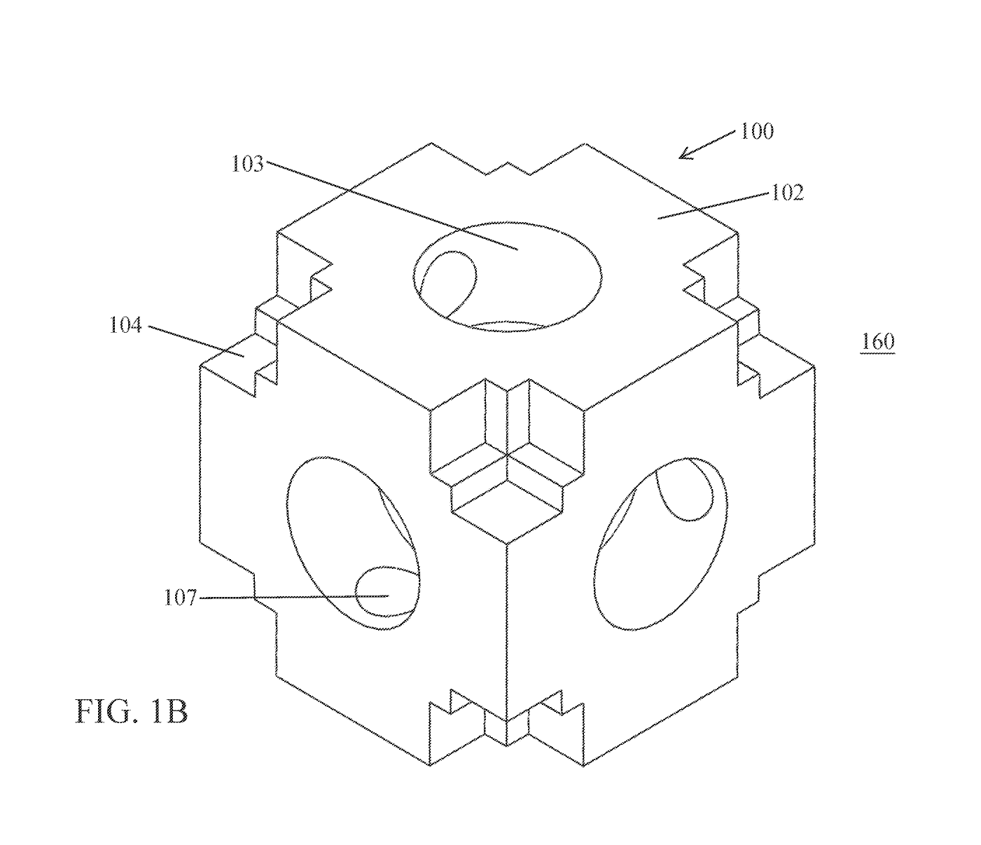

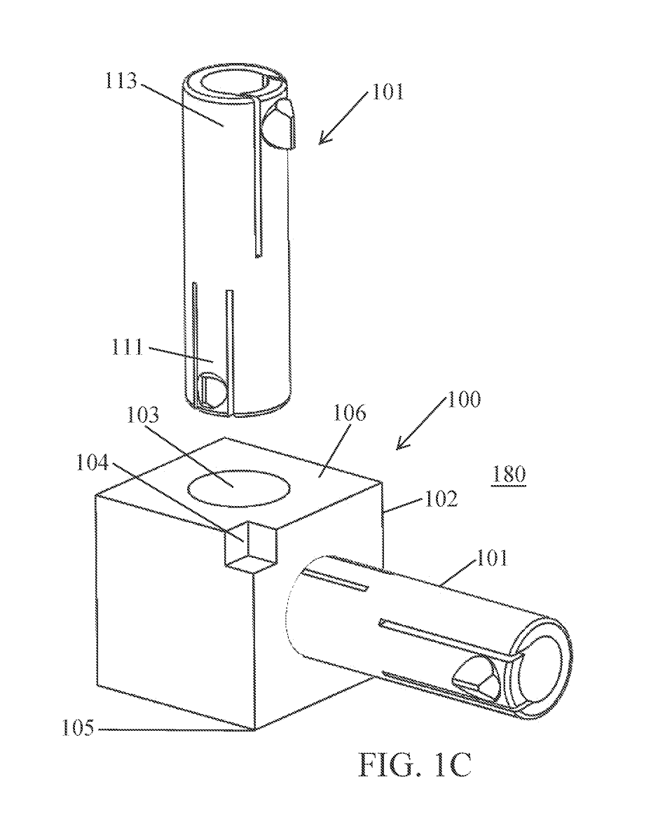

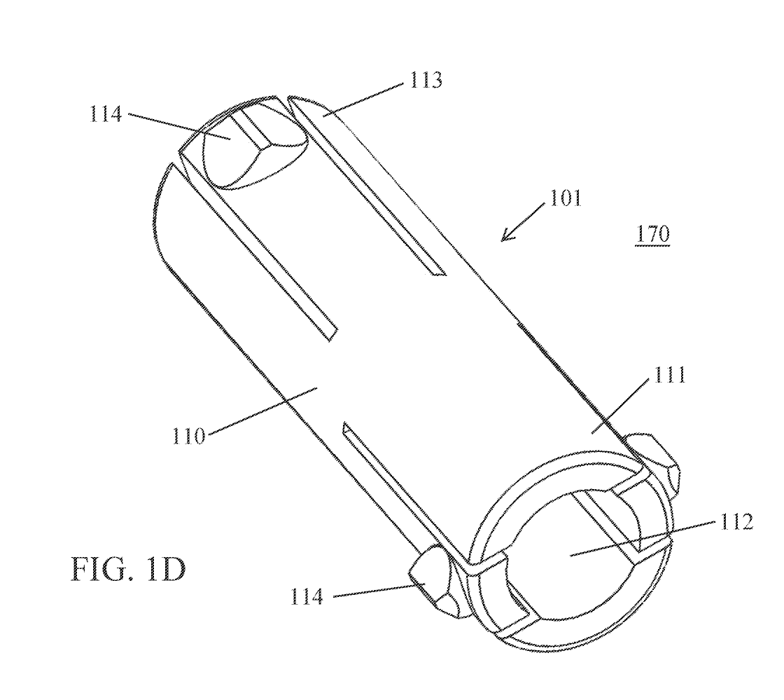

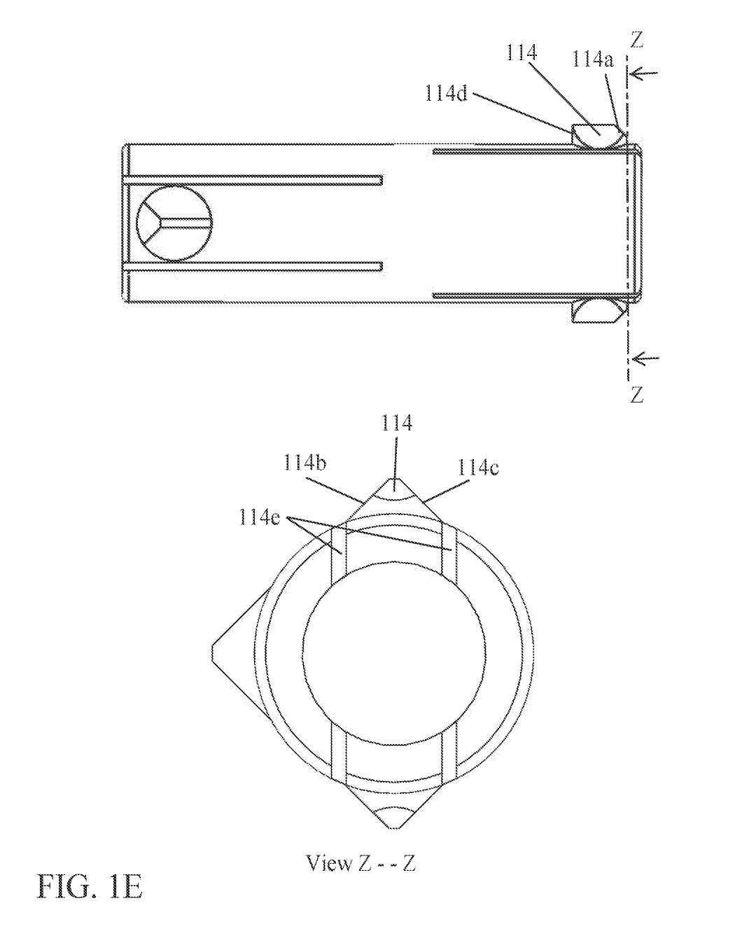

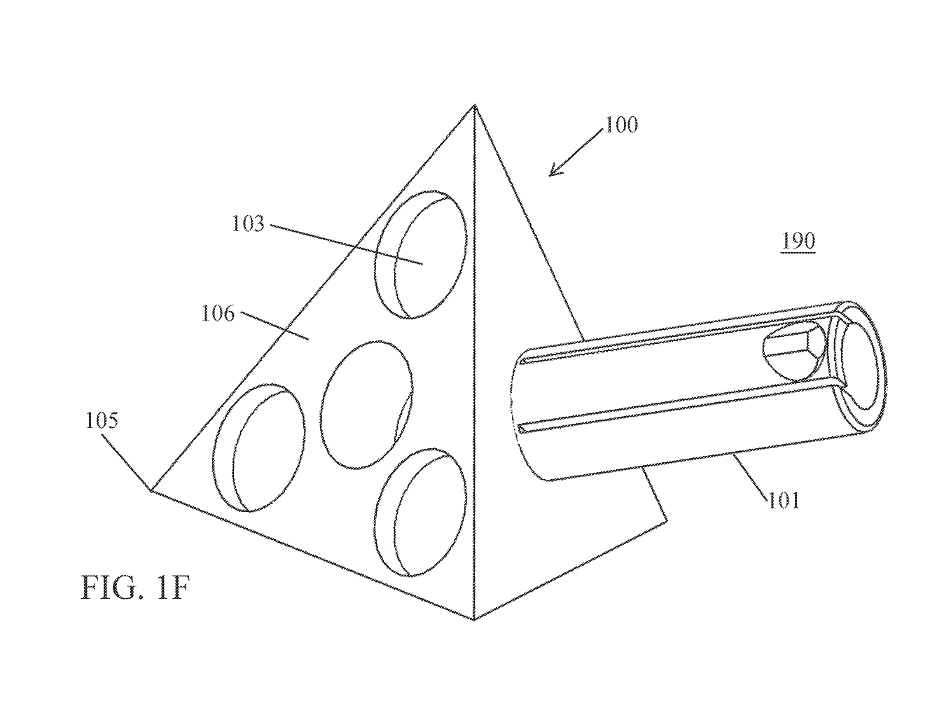

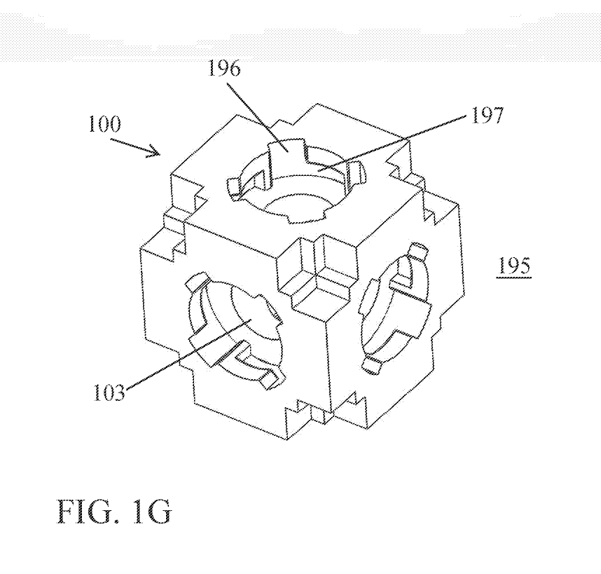

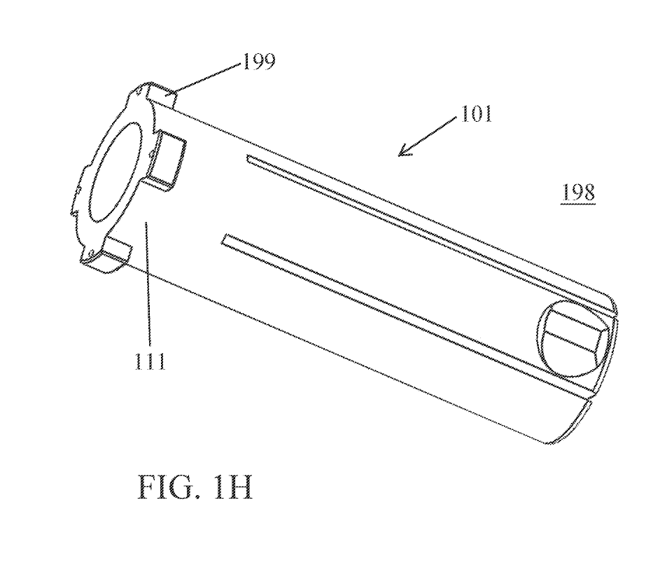

FIG. 1. is a perspective view of an embodiment of the main connector 100 and the rod 101. The main connector 100 comprises a body 102 and a hole 103 on a face 106. The hole 103 is radially disposed about the body 102.

The rod 101 comprises a rod tubular body 110, a rod insertion end 113, and a rod hollow chamber 112 traversing the rod 101 from the rod tubular body 110 through the rod insertion end 113. The rod 101 is radially disposed about the body 102. The rod 101 may be integrally formed as one unit with the body 102, as shown in structure 150. Alternatively, the rod 101 and main connector 100 may be fabricated as separate structures, as shown in structures 170 and 160, respectively.

When the rod 101 is formed as a separate structure 170, the rod 101 comprises a rod main connector end 111, a rod tubular body 110, a rod insertion end 113, and a rod hollow chamber 112 traversing the rod 101 from the rod main connector end 111 through the rod tubular body 110 and through the rod insertion end 111, and the rod main connector end 111 is adapted to be releasably engaged to the hole 103.

In an embodiment of the rod 101 formed as a separate structure 170 or as an integrally formed as one unit with the body 102, as shown in structure 150, the rod insertion end 113 comprises a rod resilient locking pin 114, which adapted to be releasably engaged to each of the main bar pin locking openings 208, which are further described below.

Similarly, in an embodiment of rod 101 formed as a separate structure 170, the rod main connector end 111 comprises a rod resilient locking pin 114, which is adapted to be releasably engaged to each of the holes 103. To releasably engage the rod resilient locking pin 114, each of the holes 103 comprises a pin aperture 107. The rod main connector end 111 may be alternatively engaged to the hole 103 by threads, twist locks, snapping joints, combinations thereof, or combinations with rod resilient locking pin 114. Preferably, the main connector end 111 comprises two rod resilient locking pins 114 and each of the holes 103 comprises two pin apertures 107. The two rod resilient locking pins 114 are adapted to be mated to the two pin apertures 107.

The rod resilient locking pin 114 comprises a chamfered rod insertion side 114a, a chamfered rod left side 114b, a chamfered rod right side 114c, and a non-chamfered rod side 114d. The rod 101 also comprises rod channels 114e parallel to the rod tubular body 110. The rod resilient locking pin 114 is situated between the rod channels 114e on the rod main connector end 111. With the rod channels 114e and the rod resilient locking pin 114 being chamfered on three sides, the rod 101 may be easily engaged to and disengaged from the main connector 100. The non-chamfered rod side 114d provides a strong connection when the rod 101 is engaged with the main connector 100. The non-chamfered rod side 114d also prevents the rod 101 from inadvertent disengagement from the main connector 100. For engagement, the rod main connector end 111 is inserted into the hole 103. The rod channels 114e allow the rod resilient locking pin 114 to radially deflect inward. If the rod resilient locking pin 114 does not engage the pin aperture 107, then the rod 101 is twisted until the rod resilient locking pin 114 engages the pin aperture 107. When engaged, the non-chamfered rod side 114d prevents disengagement when the rod 101 is attempted to be directly pulled out of the main connector 100. The rod 101 must first be twisted, which the chamfered rod left side 114b and the chamfered rod right side 114c allow. When the rod 101 is twisted, the rod resilient locking pin 114 radially deflects inward. Then the rod 101 may be pulled out of the main connector 100 for complete disengagement.

The body 102 comprises a notch 104 on a vertex 105, as shown in structure 180. The notch 104 is adapted to fit panels 1200, which are described in further detail below. Although FIG. 1 shows only a few embodiments, the invention may be practiced where the main connector 100 may be integrally formed with one or more rods 101 and may comprise one or more holes 103. For example, structure 180 depicts one possible embodiment of the present invention having one integrally formed rod 101 on one face 106, a hole 103 on another face 106 that may receive another rod 101 that is fabricated separately from the main connector 100, and another face 106 that does not have an integrally formed rod 101 nor a hole 103. Different embodiments of main connectors 100 with integrally formed rods 101 include six-way (structure 150), five-way, four-way, three-way, two-way, and one-way (structure 180) crosses. Similarly, the main connector 100 may have any combination of rods 101, as integrally formed or as a separate structure, holes 103, notches 104, vertices 105, and faces 106. Furthermore, the notches 104 may be fabricated differently, as shown in structures 150 and 160, depending upon the different applications and panels 1200 that are to be utilized, utilizations which are described in further detail below.

In another embodiment, the main connector 100 comprises a body 102 having four faces 106 and four vertices 105. This embodiment 190 of the main connector 100 is pyramidal in shape. The present invention may be practiced using main connector 100 in many shapes and forms. As shown in embodiment 190, each face 106 may comprise more than one hole 103.

In another embodiment of the present invention as shown in structure 195, main connector 100 comprises holes 103, each hole 103 having at least one receiving slot 196 and at least one locking slot 197. For the main connector 100 as depicted in structure 195, rod 101 is adapted to be fitted to main connector 100, wherein the rod 101 comprises a rod main connector end 111. The rod main connector end 111 comprises at least one nub 199. The main connector 100 and the rod 101 are fabricated to allow the rod main connector end 111 and the at least one nubs 199 to be mated to the hole 103 and the at least one receiving slot 196. To attach rod 101 to the main connector 100, the at least one nub 199 is aligned with the at least one receiving slot 196, then the rod 101 is pushed into the main connector 100. The rod 101 is then twisted whereby the at least one nub 199 is fitted into the at least one locking slot 197. Preferably, the rod main connector end 111 comprises four nubs 199 and the hole 103 comprises four receiving slots 196 and four locking slots 197.

When the rod 101 is integrally formed as one unit with the body 102, as shown in structure 150, the rod 101 comprises a rod tubular body 110, a rod insertion end 113, and a rod hollow chamber 112 traversing the rod 101 from the rod tubular body 110 through the rod insertion end 111.

Fabricating rods 101 as separate structures from the main connector 100 allows for high volume and low cost manufacture, decreased assembly costs and reduce part count for the system.

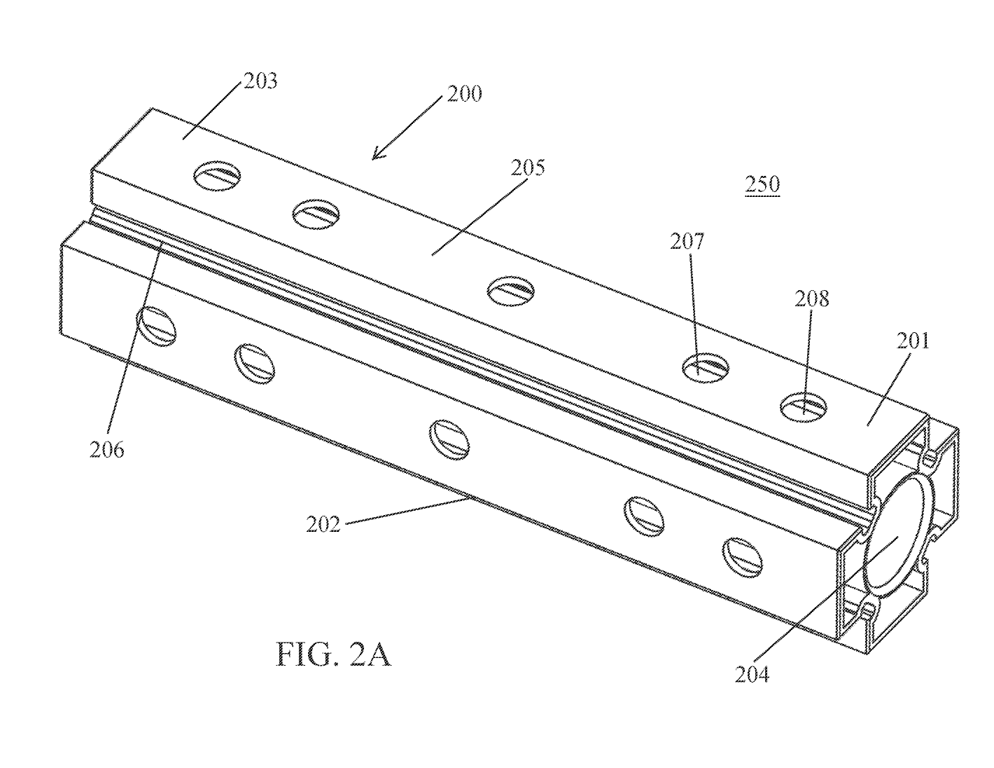

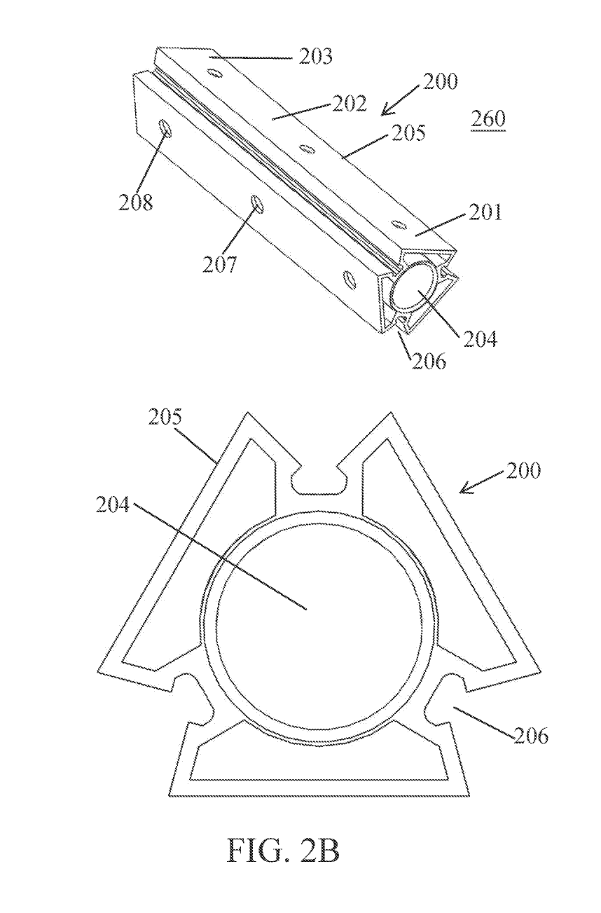

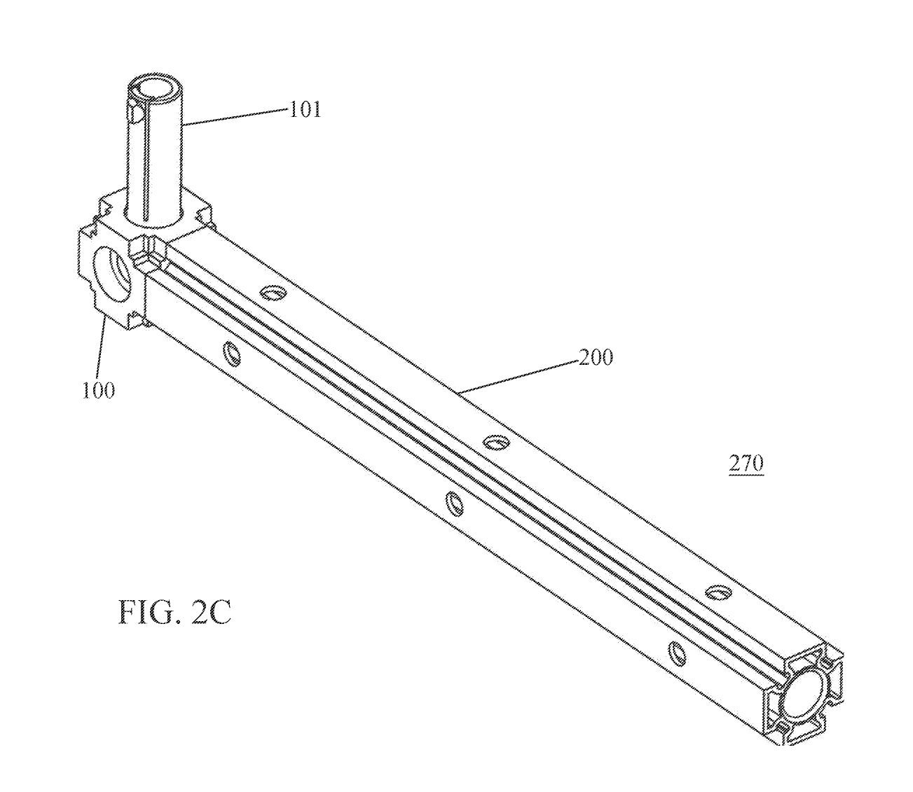

FIG. 2 is a perspective view of an embodiment of the main bar 200. The main bar 200 comprises a first receiving end 201, a main bar tubular body 202, a second receiving end 203, a main bar hollow chamber 204 traversing the main bar 200 from the first receiving end 201 through the main bar tubular body 202 to the second receiving end 203, at least three main bar longitudinal sides 205, a plurality of apertures 207 on the main bar longitudinal sides 205, and at least three main bar grooves 206 between adjacent main bar longitudinal sides 205, and the main bar grooves 206 being parallel with the main bar tubular body 202 and the main bar hollow chamber 204. The rod insertion end 111 is adapted to be fitted into the receiving ends 201, 203. The receiving ends 201, 203 comprise a plurality of main bar pin locking openings 208. The main bar pin locking openings 208 and apertures 207 begin on the main bar longitudinal sides 205 and continue through to the main bar hollow chamber 204.

In another embodiment of the main bar 200, each of the main bar longitudinal sides 205 has a T-shaped cross section, as shown from an end view of the main bar 200. The main bar longitudinal sides 205 may be solid or hollow. Although the main bar 200 is shown with three and four main bar longitudinal sides 205 and three and four main bar grooves 206 in structures 260 and 250, respectively. The scope of the present invention is not limited to only three or four main bar longitudinal sides 205 and three or four main bar grooves 206. Fabricating the main bar longitudinal sides 205 as hollow is advantageous as it reduces the weight of the main bar 200 and reduces the cost by decreasing the amount of manufacturing materials.

An embodiment of the present invention is depicted as structure 270, where a main bar 200 is releasably engaged with a rod 101, and the rod 101 is then joined with the main connector 100. As shown by structure 270, rod 101 is hidden and not seen when the main connector 100, the rod 101 and the main bar 200 are assembled. Structure 270 also depicts a second rod 101 that is joined to main connector 100, but this second rod 101 is not hidden and can be seen because this second rod 101 is not releasably engaged with a second main bar 200. The two rods 101 may be either integrally formed with or fabricated as a separate structure from the main connector 100.

Like with main connector 100, the rod 101 may be easily engaged to and disengaged from the main bar 200. The non-chamfered rod side 114d provides a strong connection when the rod 101 is engaged with the main bar 200. The non-chamfered rod side 114d also prevents the rod 101 from inadvertent disengagement from the main bar 200. For engagement, the rod insertion end 113 is inserted into the main bar 200. The rod channels 114e allow the rod resilient locking pin 114 to radially deflect inward. If the rod resilient locking pin 114 does not engage the main bar pin locking opening 208, then the rod 101 is twisted until the rod resilient locking pin 114 engages the main bar pin locking openings 208. When engaged, the non-chamfered rod side 114d prevents disengagement when the rod 101 is attempted to be directly pulled out of the main bar 200. The rod 101 must first be twisted, which the chamfered rod left side 114b and the chamfered rod right side 114c allow. When the rod 101 is twisted, the rod resilient locking pin 114 radially deflects inward. Then the rod 101 may be pulled out of the main bar 200 for complete disengagement.

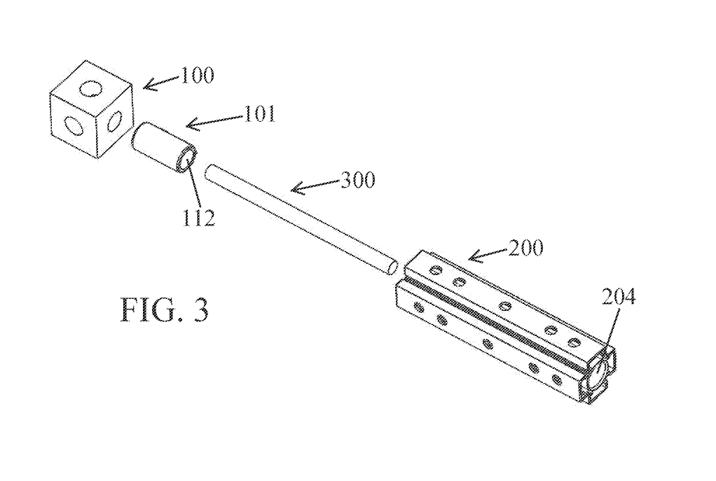

FIG. 3 is an exploded view of an embodiment of the main connector block 100, rod 101, reinforcement rod 300, and main bar 200. The reinforcement rod 300 is adapted to be fitted within the main bar hollow chamber 204 and is adapted to be fitted within the rod hollow chamber 112. The reinforcement rod 300, which may be hollow or solid, provides additional support and additional strength to an assembled structure of the present invention.

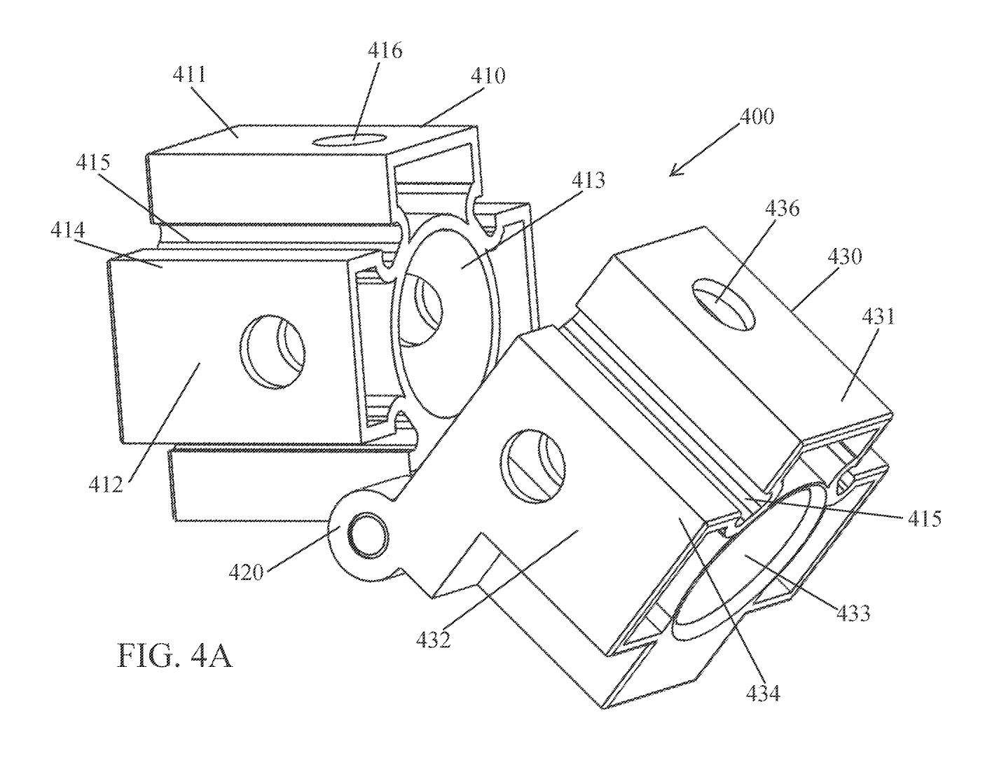

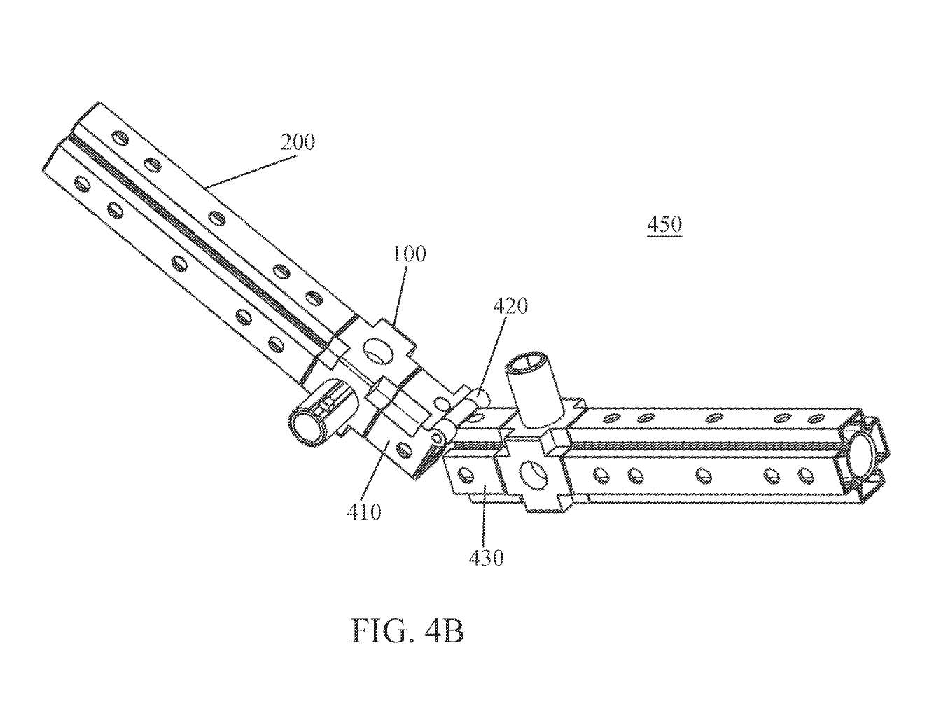

FIG. 4 is a perspective view of an embodiment of the inside bar hanger connector 400. The inside bar hanger connector 400 comprises a first inside bar hanger section 410, a inside bar hanger joint 420, and a second inside bar hanger section 430. The first inside bar hanger section 410 comprises a first inside bar hanger end 411, a first inside bar hanger tubular body 412, a first inside bar hanger hollow chamber 413 traversing the first inside bar hanger end 411 through the first inside bar hanger tubular body 412, at least three first inside bar hanger longitudinal sides 414, and at least three first inside bar hanger grooves 415 between adjacent first inside bar hanger longitudinal sides 414, the first inside bar hanger grooves 415 being parallel with the first inside bar hanger tubular body 412 and the first inside bar hanger hollow chamber 413. The first inside bar hanger end 411 comprises a plurality of first inside bar hanger pin locking openings 416. Each of the first inside bar hanger longitudinal sides 414 has a T-shaped cross section. The first inside bar hanger longitudinal sides 414 may be solid or hollow.

The second inside bar hanger section 430 comprises a second inside bar hanger end 431, a second inside bar hanger tubular body 432, a second inside bar hanger hollow chamber 433 traversing the second inside bar hanger end 431 through the second inside bar hanger tubular body 432, at least three second inside bar hanger longitudinal sides 434, and at least three second inside bar hanger grooves 435 between adjacent second inside bar hanger longitudinal sides 434, the second inside bar hanger grooves 435 being parallel with the second inside bar hanger tubular body 432 and the second inside bar hanger hollow chamber 433. The second inside bar hanger end 431 comprises a plurality of second inside bar hanger pin locking openings 436. Each of the second inside bar hanger longitudinal sides 434 has a T-shaped cross section. The second inside bar hanger longitudinal sides 434 may be solid or hollow. Like the main bar pin locking openings 208 and apertures 207, the inside bar hanger pin openings 416, 436 begin on the inside bar hanger longitudinal sides 414, 434 and continue through to the inside bar hanger hollow chambers 413, 433. Fabrication of the inside bar hanger longitudinal sides 414, 434 as hollow is advantageous as it reduces the weight of the inside bar hanger connector 400 and reduces the cost by decreasing the amount of manufacturing materials.

The rod resilient locking pins 114 are adapted to be releasably engaged to each of the inside bar hanger pin openings 416, 436. The inside bar hanger joint 420 is adapted to allow the first inside bar hanger section 410 to flex in relation to the second inside bar hanger section 430. The reinforcement rod 300 is adapted to be fitted within the inside bar hanger hollow chambers 413, 433.

An embodiment of the present invention is depicted as structure 450, where a main bar 200 is releasably engaged with a rod 101, the rod 101 is then joined with the main connector 100, the main connector 100 is then joined with a second rod 101, the second rod 101 is releasably engaged with the first inside bar hanger section 410 of the inside bar hanger connector 400. Then the second inside bar hanger section 430 of the inside bar hanger connector 400 is releasably engaged with a third rod 101, the third rod 101 is then connected with a second main connector 100, the second main connector 100 is then connected with a fourth rod 101, the fourth rod is releasably engaged with a second main bar 200. As shown by structure 450, the four rods 101 are hidden and not seen when the main connectors 100, the rods 101, the inside bar hanger connector 400 and the main bars 200 are assembled. Structure 450 also depicts a fifth and sixth rod 101 that are joined to the main connectors 100, but the fifth and sixth rods 101 are not hidden and can be seen because these rods 101 are not releasably engaged with a third and fourth main bar 200. The present invention allows various configurations where more rods 101 and main bars 200 may be added to structure 450. The six rods 101 may be either integrally formed with or fabricated as a separate structure from the main connectors 100.

Like main bar 200, although the inside bar hanger connector 400 is shown with four inside bar hanger longitudinal sides 414, 434 and four inside bar hanger grooves 415, 435 in structure 450, the scope of the present invention is not limited to only four inside bar hanger longitudinal sides 414, 434 or four inside bar hanger grooves 415, 435.

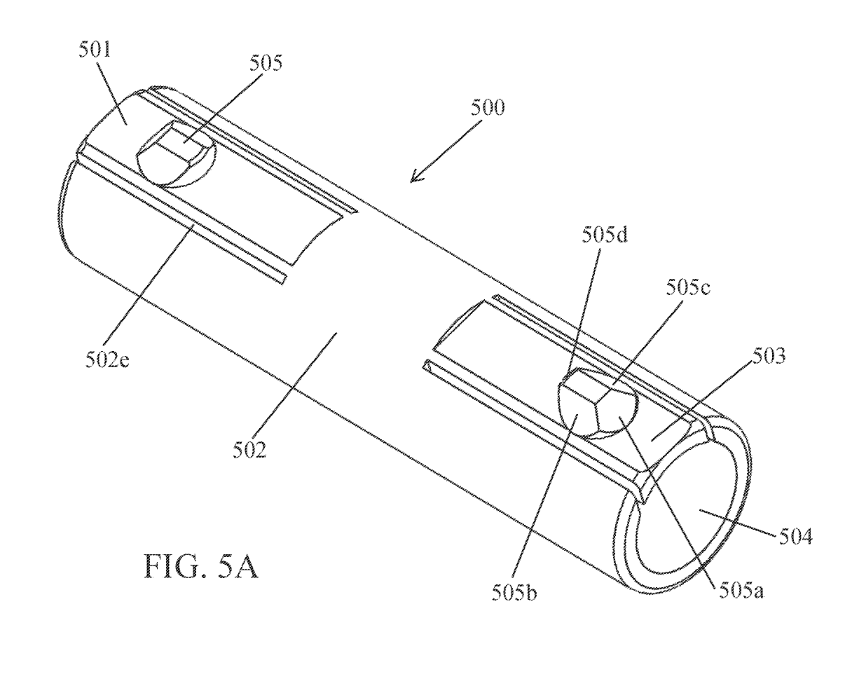

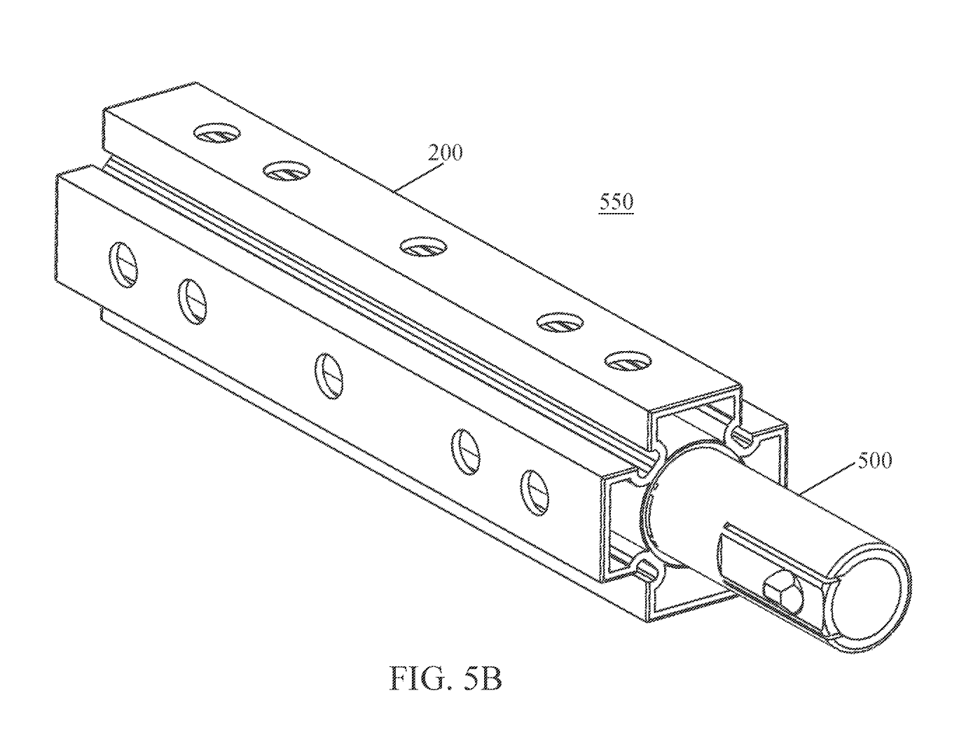

FIG. 5 is a perspective view of an embodiment of the main bar splice 500. The main bar splice 500 comprises a first splice end 501, a splice tubular body 502, a second splice end 503, and a splice hollow chamber 504 traversing the main bar splice 500 from the first splice end 501 through the splice tubular body 502 to the second splice end 503. The splice ends 501, 503 comprise a plurality of splice resilient locking pins 505. Each of the splice resilient locking pins 505 are adapted to be releasably engaged to each of the main bar pin locking openings 208. Each of the splice resilient locking pins 505 are adapted to be releasably engaged to each of the inside bar hanger pin locking openings 416, 436. The reinforcement rod 300 is adapted to be fitted within the splice hollow chamber 504.

An embodiment of the present invention is depicted as structure 550, where a main bar 200 is releasably engaged with a main bar splice 500. Like the rod resilient locking pin 114, the splice resilient locking pin 505 comprises a chamfered splice insertion side 505a, a chamfered splice left side 505b, a chamfered splice right side 505c, and a non-chamfered splice side 505d. The main bar splice 500 also comprises splice channels 505e parallel to the splice tubular body 502. The splice resilient locking pin 505 is situated between the splice channels 505e on the splice ends 501, 503. With the splice channels 505e and the splice resilient locking pin 505 being chamfered on three sides, the main bar splice 500 may be easily engaged to and disengaged from the main bar 200. The non-chamfered splice side 505d provides a strong connection when the main bar splice 500 is engaged with the main bar 200. The non-chamfered splice side 505d also prevents the main bar splice 500 from inadvertent disengagement from the main bar 200. For engagement, the splice end 501, 503 is inserted into the main bar 200. The splice channels 505e allow the splice resilient locking pin 505 to radially deflect inward. If the splice resilient locking pin 505 does not engage the main bar pin locking opening 208, then the main bar splice 500 is twisted until the splice resilient locking pin 505 engages the main bar pin locking opening 208. When engaged, the non-chamfered splice side 505d prevents disengagement when the main bar splice 500 is attempted to be directly pulled out of the main bar 200. The main bar splice 500 must first be twisted, which the chamfered splice left side 505b and the chamfered splice right side 505c allow. When the main bar splice 500 is twisted, the splice resilient locking pin 505 radially deflects inward. Then the main bar splice 500 may be pulled out of the main bar 200 for complete disengagement.

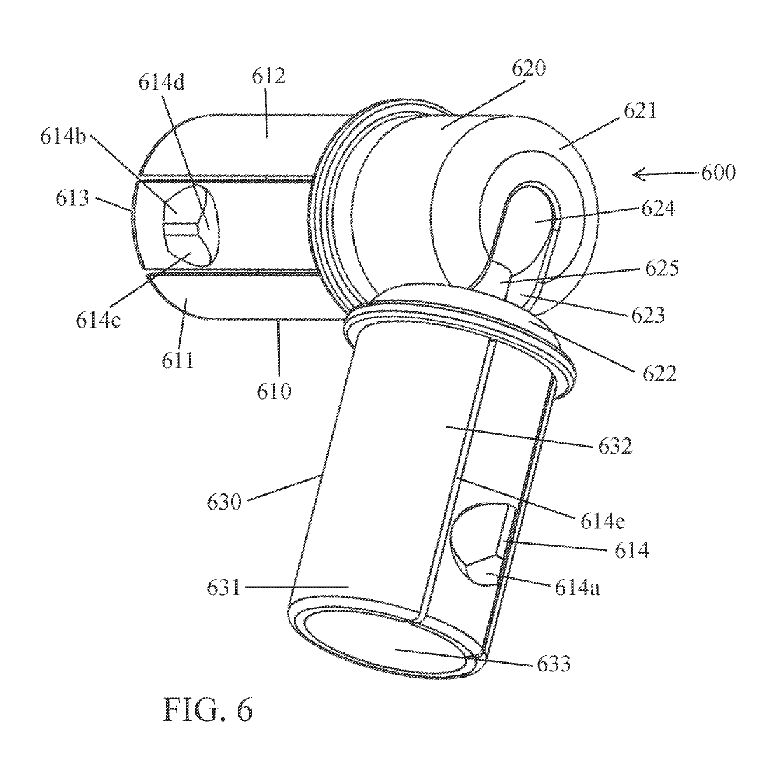

FIG. 6 is a perspective view of an embodiment of the ball and socket connector 600. The ball and socket connector 600 comprises a first ball and socket section 610, a ball and socket joint 620, and a second ball and socket section 630.

The first ball and socket section 610 comprises first ball and socket end 611, a first ball and socket tubular body 612, and a first ball and socket hollow chamber 613 traversing the first ball and socket end 611 through the first ball and socket tubular body 612. The second ball and socket section 630 comprises a second ball and socket end 631, a second ball and socket tubular body 632, and a second ball and socket hollow chamber 633 traversing the second ball and socket end 631 through the second ball and socket tubular body 632.

The socket joint 620 comprises a socket portion 621 and a ball portion 622. The socket portion 621 comprises a ball slot 623. The ball portion comprises a ball body 624 and a ball arm 625. The ball arm 625 extends from the ball portion 622. The ball body 624 extends from the ball arm 625. The ball slot 623 is adapted to allow the ball arm 625 to move into the socket portion 621, whereby the ball and socket joint 620 allows the first ball and socket section 610 to move up to ninety degrees in relation to the second ball and socket section 630. The first ball and socket section 610 is adapted to spin while the socket portion 621 is stationary, whereby the first ball and socket section 610 may spin up to three hundred sixty degrees. Similarly, the second ball and socket section 630 is adapted to spin while the socket portion 621 is stationary, whereby the second ball and socket section 630 may spin up to three hundred sixty degrees.

The ball and socket ends 611, 631 comprise a plurality of ball and socket resilient locking pins 614. Each of the ball and socket resilient locking pins 614 are adapted to be releasably engaged to each of the main bar pin locking openings 208. Each of the ball and socket resilient locking pins 614 are adapted to be releasably engaged to each of the inside bar hanger pin locking openings 416, 436. The ball and socket joint 620 is adapted to allow the first ball and socket section 610 to rotate in relation to the second ball and socket section 630. The reinforcement rod 300 is adapted to be fitted within the ball and socket hollow chambers 613, 633.

Like the rod resilient locking pin 114, the ball and socket resilient locking pin 614 comprises a chamfered ball and socket insertion side 614a, a chamfered ball and socket left side 614b, a chamfered ball and socket right side 614c, and a non-chamfered ball and socket side 614d. The ball and socket connector 600 also comprises ball and socket channels 614e parallel to the ball and socket tubular body 612, 632. The ball and socket resilient locking pin 614 is situated between the ball and socket channels 614e on the ball and socket ends 611, 631. With the ball and socket channels 614e and the ball and socket resilient locking pin 614 being chamfered on three sides, the ball and socket connector 600 may be easily engaged to and disengaged from the main bar 200. The non-chamfered ball and socket side 614d provides a strong connection when the ball and socket connector 600 is engaged with the main bar 200. The non-chamfered ball and socket side 614d also prevents the ball and socket connector 600 from inadvertent disengagement from the main bar 200. For engagement, the ball and socket end 611, 631 is inserted into the main bar 200. The ball and socket channels 614e allow the ball and socket resilient locking pin 614 to radially deflect inward. If the ball and socket resilient locking pin 614 does not engage the main bar pin locking opening 208, then the ball and socket connector 600 is twisted until the ball and socket resilient locking pin 614 engages the main bar pin locking opening 208. When engaged, the non-chamfered ball and socket side 614d prevents disengagement when the ball and socket connector 600 is attempted to be directly pulled out of the main bar 200. The ball and socket connector 600 must first be twisted, which the chamfered ball and socket left side 614b and the chamfered ball and socket right side 614c allow. When the ball and socket connector 600 is twisted, the ball and socket resilient locking pin 614 radially deflects inward. Then the ball and socket connector 600 may be pulled out of the main bar 200 for complete disengagement.

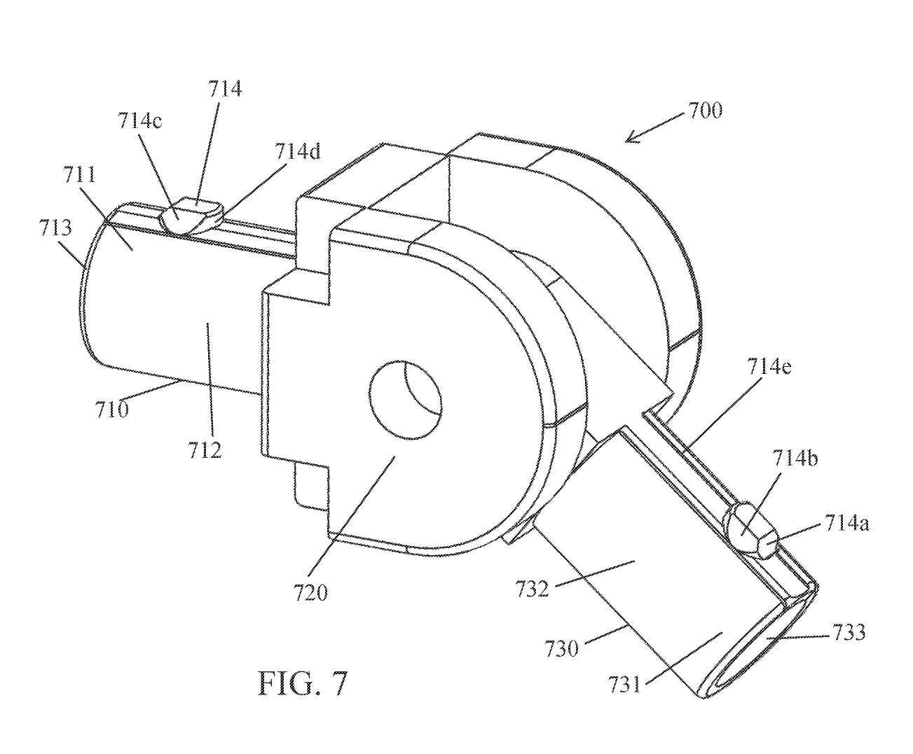

FIG. 7 is a perspective view of an embodiment of the flexible angle corner connector 700. The flexible angle corner connector 700 comprises a first flexible angle corner section 710, a flexible angle corner joint 720, and a second flexible angle corner section 730.

The first flexible angle corner section 710 comprises a first flexible angle corner end 711, a first flexible angle corner tubular body 712, and a first flexible angle corner hollow chamber 713 traversing the first flexible angle corner end 711 through the first flexible angle corner tubular body 712. The second flexible angle corner section 730 comprises a second flexible angle corner end 731, a second flexible angle corner tubular body 732, and a second flexible angle corner hollow chamber 733 traversing the second flexible angle corner end 731 through the second flexible angle corner tubular body 732.

The flexible angle corner ends 711, 731 comprise a plurality of flexible angle corner resilient locking pins 714. Each of the flexible angle corner resilient locking pins 714 are adapted to be releasably engaged to each of the main bar pin locking openings 208. Each of the flexible angle corner resilient locking pins 714 are adapted to be releasably engaged to each of the inside bar hanger pin locking openings 416, 436. The flexible angle corner joint 720 is adapted to allow the first flexible angle corner section 710 to flex in relation to the second flexible angle corner section 730, whereby the flexible angle corner joint 720 is adapted to allow the second flexible angle corner section 730 to flex up to one hundred eighty degrees. The angle between the first flexible angle corner section 710 and the second flexible corner section 730 ranges from ninety degrees to two hundred seventy degrees. The reinforcement rod 300 is adapted to be fitted within the flexible angle corner hollow chambers 713, 733.

Like the rod resilient locking pin 114, the flexible angle corner resilient locking pin 714 comprises a chamfered flexible angle corner insertion side 714a, a chamfered flexible angle corner left side 714b, a chamfered flexible angle corner right side 714c, and a non-chamfered flexible angle corner side 714d. The flexible angle corner connector 700 also comprises flexible angle corner channels 714e parallel to the flexible angle corner tubular body 712, 732. The flexible angle corner resilient locking pin 714 is situated between the flexible angle corner channels 714e on the flexible angle corner ends 711, 731. With the flexible angle corner channels 714e and the flexible angle corner resilient locking pin 714 being chamfered on three sides, the flexible angle corner connector 700 may be easily engaged to and disengaged from the main bar 200. The non-chamfered flexible angle corner side 714d provides a strong connection when the flexible angle corner connector 700 is engaged with the main bar 200. The non-chamfered flexible angle corner side 714d also prevents the flexible angle corner connector 700 from inadvertent disengagement from the main bar 200. For engagement, the flexible angle corner end 711, 731 is inserted into the main bar 200. The flexible angle corner channels 714e allow the flexible angle corner resilient locking pin 714 to radially deflect inward. If the flexible angle corner resilient locking pin 714 does not engage the main bar pin locking opening 208, then the flexible angle corner connector 700 is twisted until the flexible angle corner resilient locking pin 714 engages the main bar pin locking opening 208. When engaged, the non-chamfered flexible angle corner side 714d prevents disengagement when the flexible angle corner connector 700 is attempted to be directly pulled out of the main bar 200. The flexible angle corner connector 700 must first be twisted, which the chamfered flexible angle corner left side 714b and the chamfered flexible angle corner right side 714c allow. When the flexible angle corner connector 700 is twisted, the flexible angle corner resilient locking pin 714 radially deflects inward. Then the flexible angle corner connector 700 may be pulled out of the main bar 200 for complete disengagement.

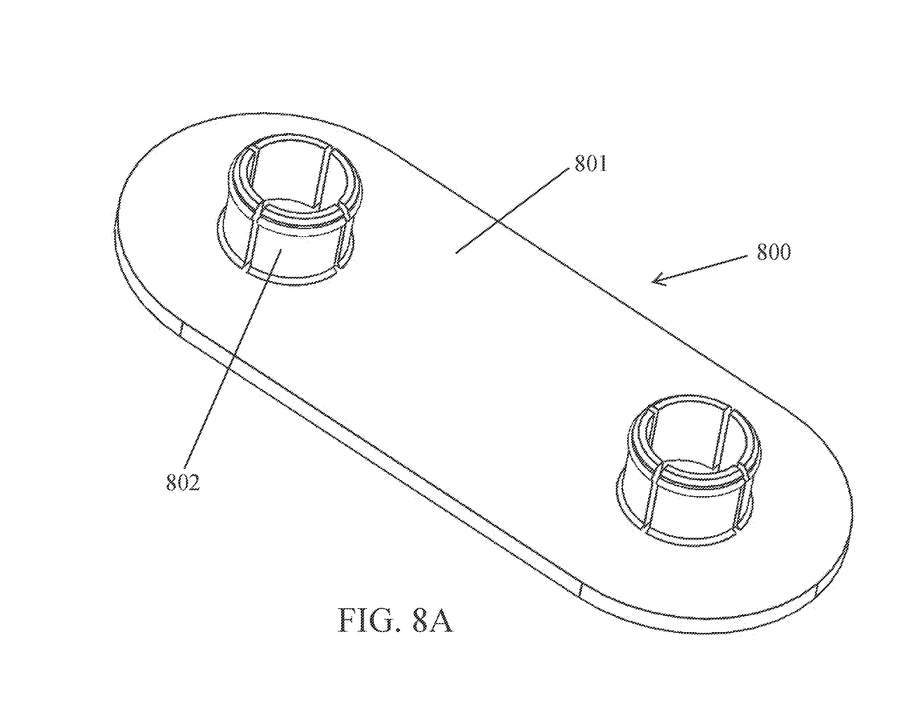

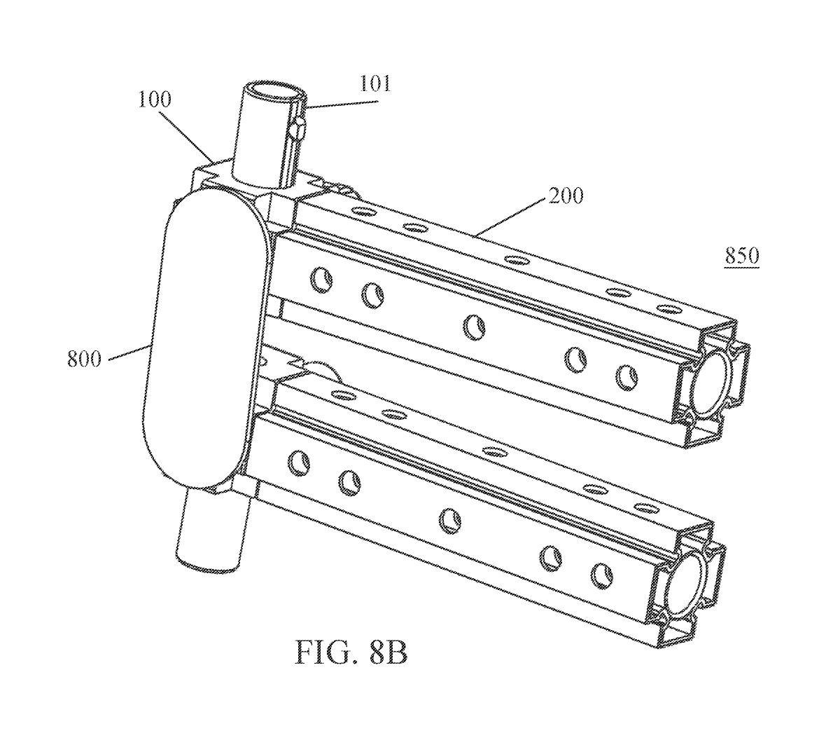

FIG. 8 is a perspective view of an embodiment of the outside angle bar hanger connector 800. The outside angle bar hanger connector 800 comprises a plate 801 and a plurality of outside angle bar hanger insertion pins 802. The outside angle bar hanger insertion pins 802 are adapted to be releasably engaged to the hole 103 of the main connector 100.

An embodiment of the present invention is depicted as structure 850, where a main bar 200 is releasably engaged with a rod 101, the rod 101 is then joined with the main connector 100, the main connector 100 is then releasably engaged to the outside angle bar hanger connector 800 by one outside angle bar hanger insertion pin 802. A second outside angle bar hanger insertion pin 802 on the same outside angle bar hanger connector is releasably engaged to a second main connector 100, the second main connector 100 is joined with a second rod 101, and the second rod 101 is releasably engaged to a second main bar 200. Each main connector 100 may be pivoted about the outside angle bar hanger insertion pin 802 to which the main connector 100 is connected.

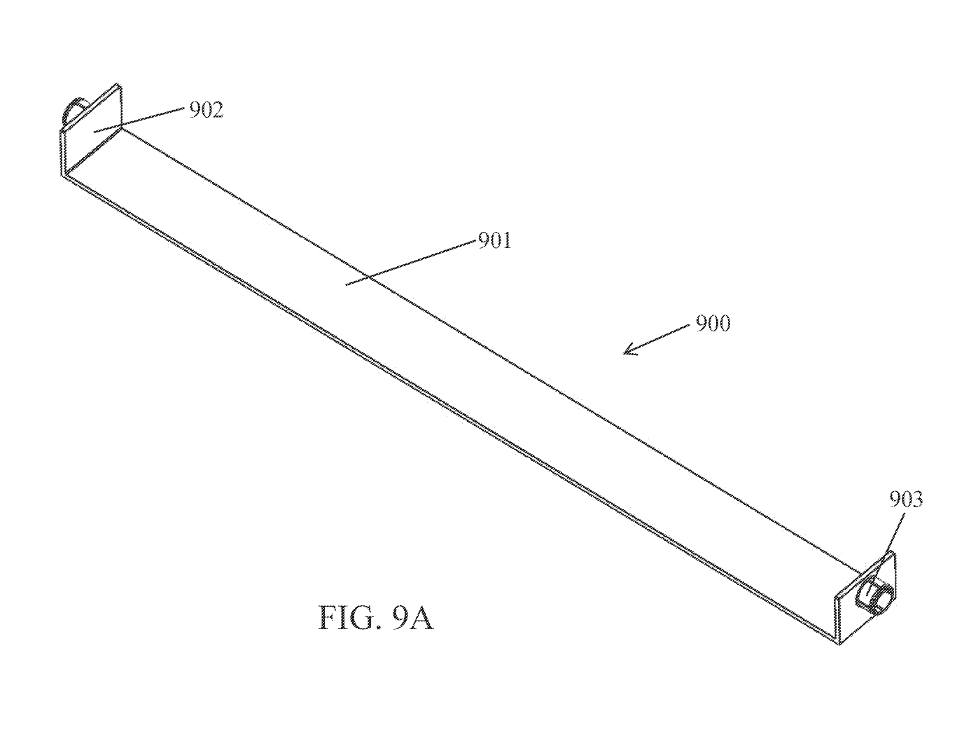

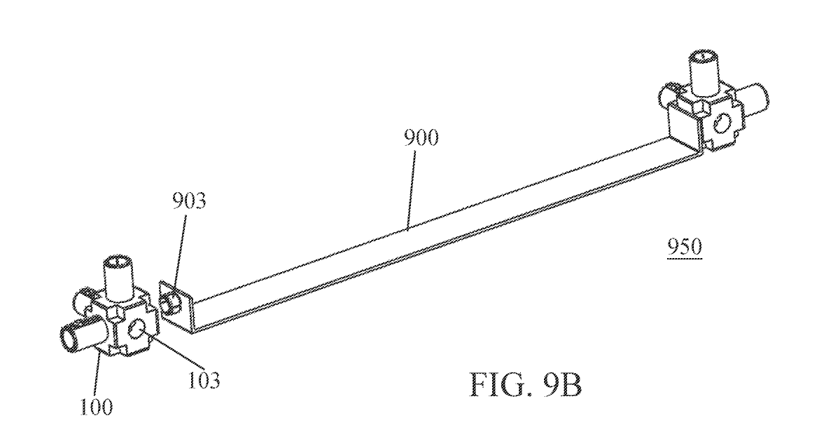

FIG. 9 is a perspective view of an embodiment of the angled low profile bar 900. The angled low profile bar 900 comprises an angled low profile bar body 901, a plurality of upright extensions 902, and a plurality of angled low profile bar insertion pins 903. The angled low profile bar body 901 is adapted to have a predetermined angle to the upright extensions 903. The predetermined angle is based upon the geometry of the main connector 100. The angled low profile bar insertion pins 903 are adapted to be releasably engaged to the hole 103 of the main connector 100. The angled low profile bar insertion pins 903 may be on the inside of the upright extensions 903 (not shown).

An embodiment of the present invention is depicted as structure 950, where a angled low profile bar 900 is releasably engaged with a main connector 100, where the angled low profile bar insertion pin 903 is releasably engaged to the hole 103 of the main connector 100.

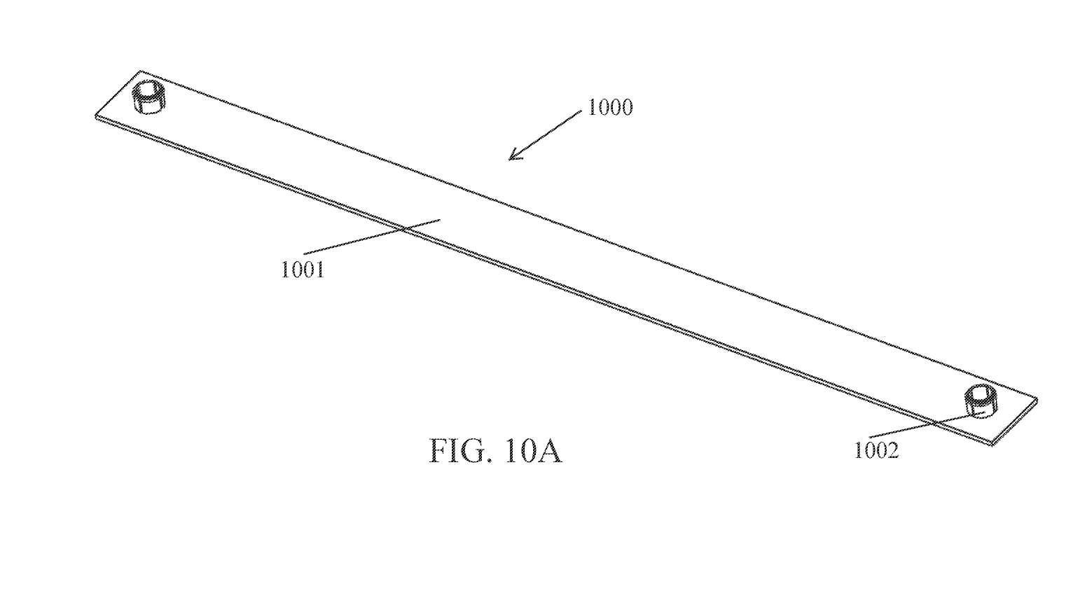

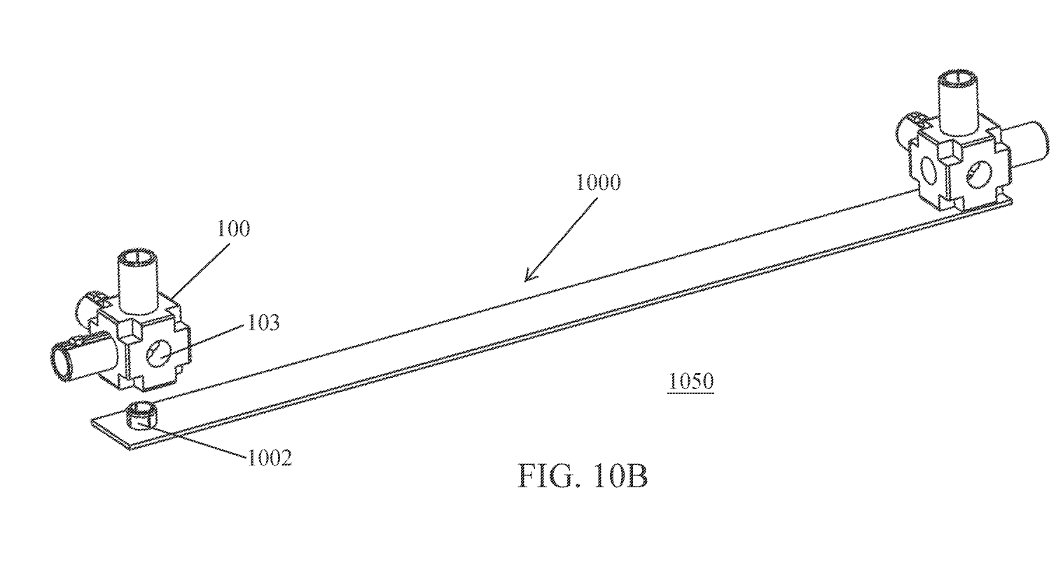

FIG. 10 is a perspective view of an embodiment of the flat low profile bar 1000. The flat low profile bar 1000 comprises a flat low profile bar body 1001 and a plurality of flat low profile bar insertion pins 1002. The flat low profile bar insertion pins 1002 are adapted to be releasably engaged to the hole 103 of the main connector 100.

An embodiment of the present invention is depicted as structure 1050, where a flat low profile bar 1000 is releasably engaged with a main connector 100, where the flat low profile bar insertion pin 1002 is releasably engaged to the hole 103 of the main connector 100.

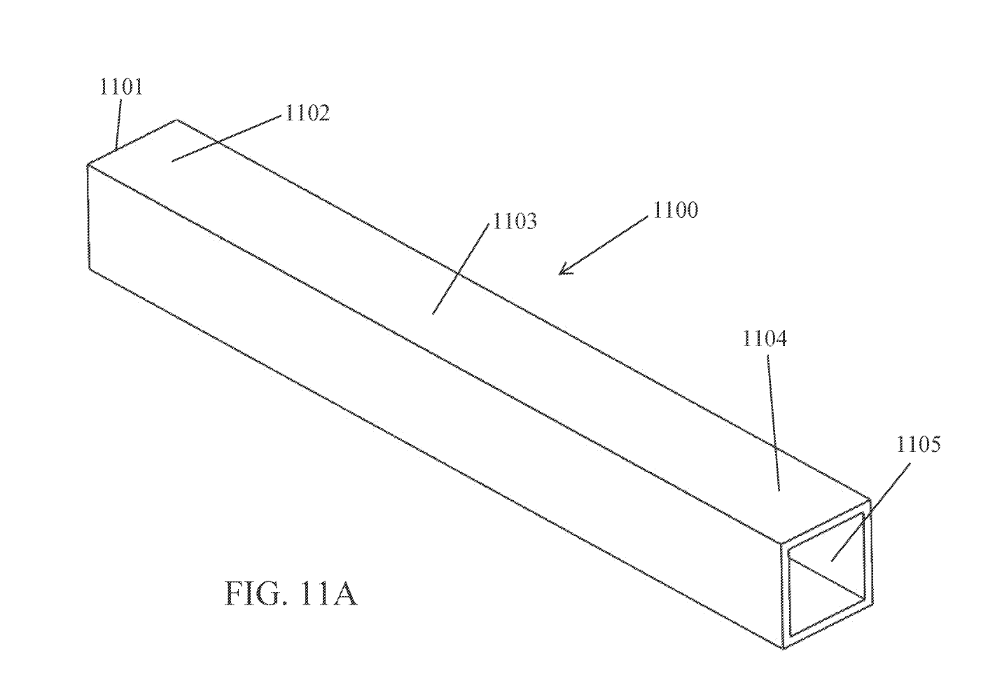

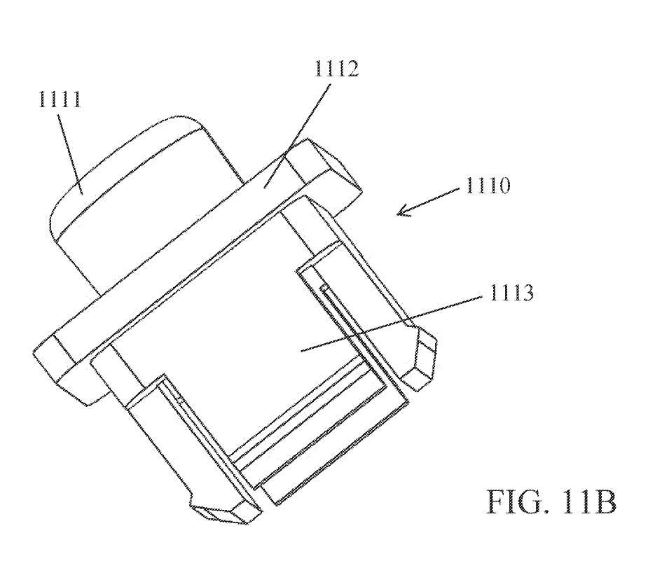

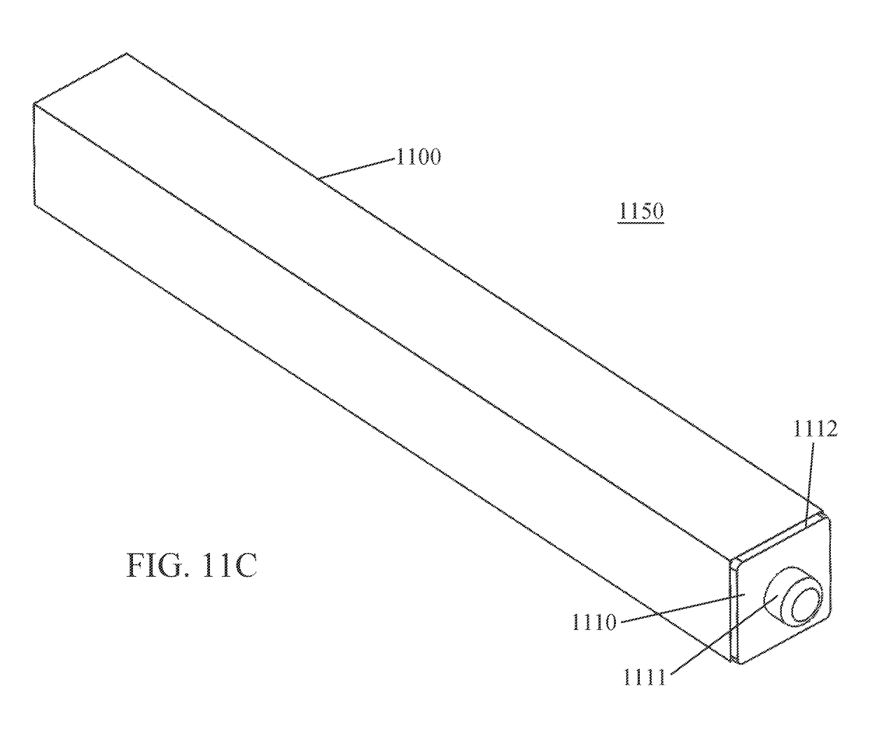

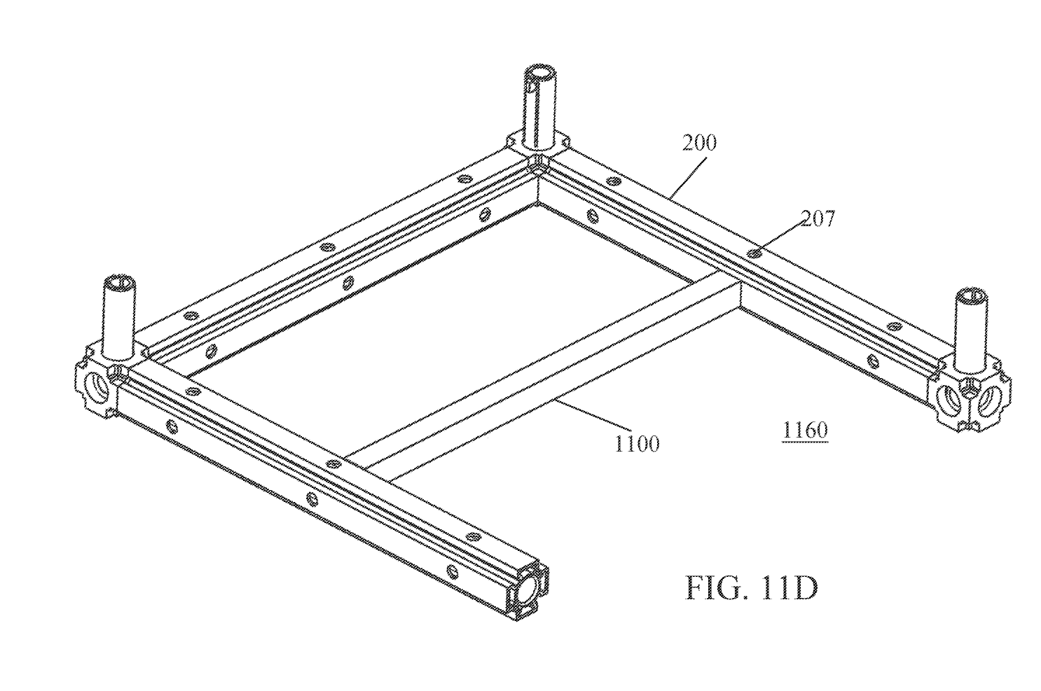

FIG. 11 is a perspective view of an embodiment of the cross bar 1100 and the cross bar connector 1110. The cross bar 1100 comprises a first cross bar opening 1101, a first cross bar end 1102, a cross bar body 1103, a second cross bar end 1104, and a second cross bar opening 1105. The cross bar connector 1110 comprises a cross bar connector insertion pin 1111, a flange 1112, and cross bar insertion end 1113. The cross bar insertion end 1113 is adapted to be releasably engaged to the cross bar openings 1101, 1104. The cross bar connector insertion pin 1111 is adapted to be releasably engaged to each of the apertures 207 of the main bar 200.

An embodiment of the present invention is depicted as structure 1150, where a cross bar connector 1110 is releasably engaged with a cross bar 1100. The flange 1112 aids in correctly positioning the cross bar connector 1110 in the cross bar 1100 by preventing the cross bar connector 1110 from being inserted too deep into the cross bar 1100.

An embodiment of the present invention is depicted as structure 1160, where a cross bar 1100 with two releasably engaged cross bar connectors 1110 is providing support to the structure 1160. The two cross bar connector insertion pins 1111 are releasably engaged in two apertures 207 of the main bars 200. Preferably, the cross bar connector insertion pins 1111 are spring loaded, which allows the insertion of the cross bar 1100 after the other components of structure 1160 are already assembled. Utilization of the cross bar 1100 and cross bar connectors 1110 serves to strengthen the structure 1160 and provide support for panels 1200, which are further described below.

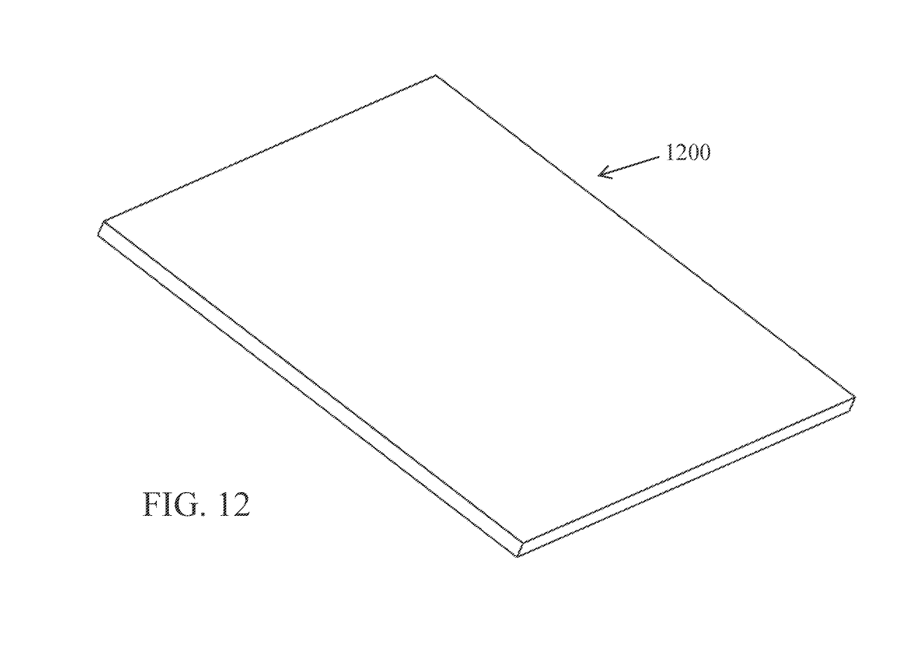

FIG. 12 is a perspective view of an embodiment of the panel 1200. Panel 1200 may be fabricated in different sizes and thicknesses and from different materials depending upon the application. Panels 1200 may also have any number of various shaped holes cut in them to allow passage into or out of an assembled structure. The holes in panels 1200 may facilitate the installation of a door or window. Panel 1200 may be fabricated from different materials including, but not limited to, plastics, metals, wood, fiberglass, glass, fabrics, composites, ceramics, and combinations thereof. For example, panel 1200 may be fabricated with acrylic glass, which allows a view of the interior of an assembled structure.

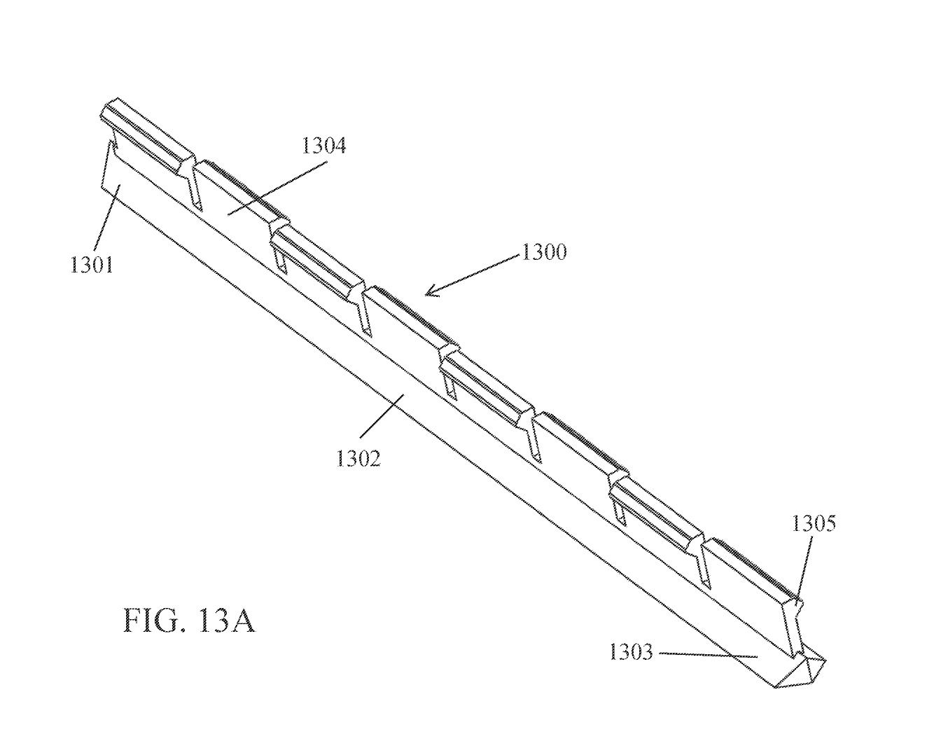

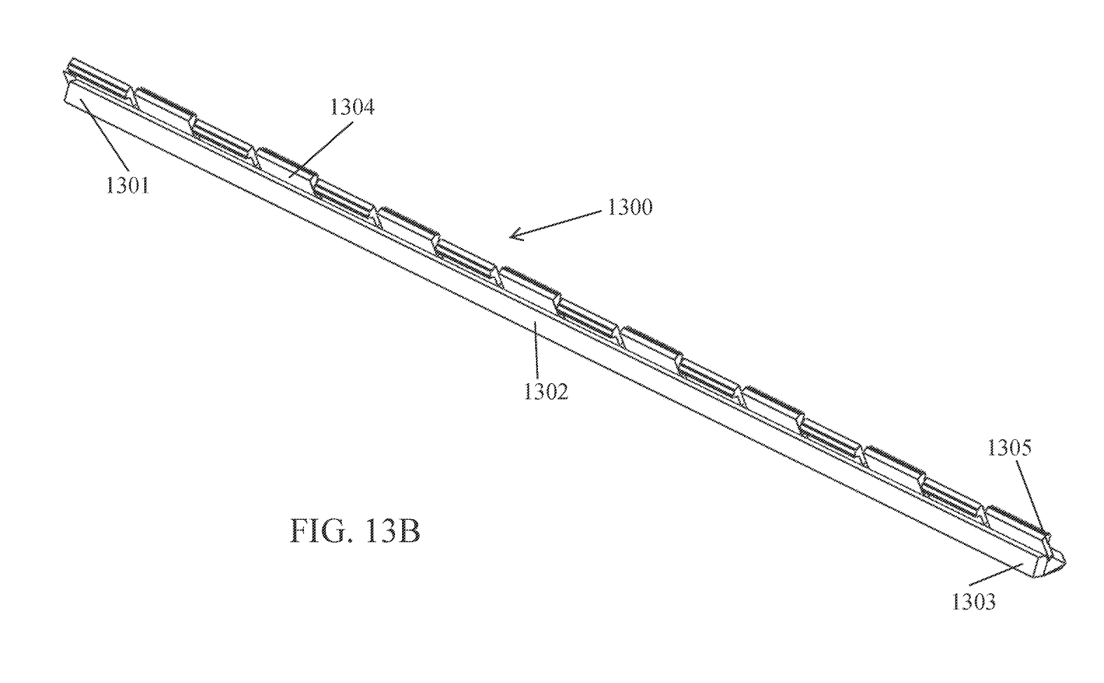

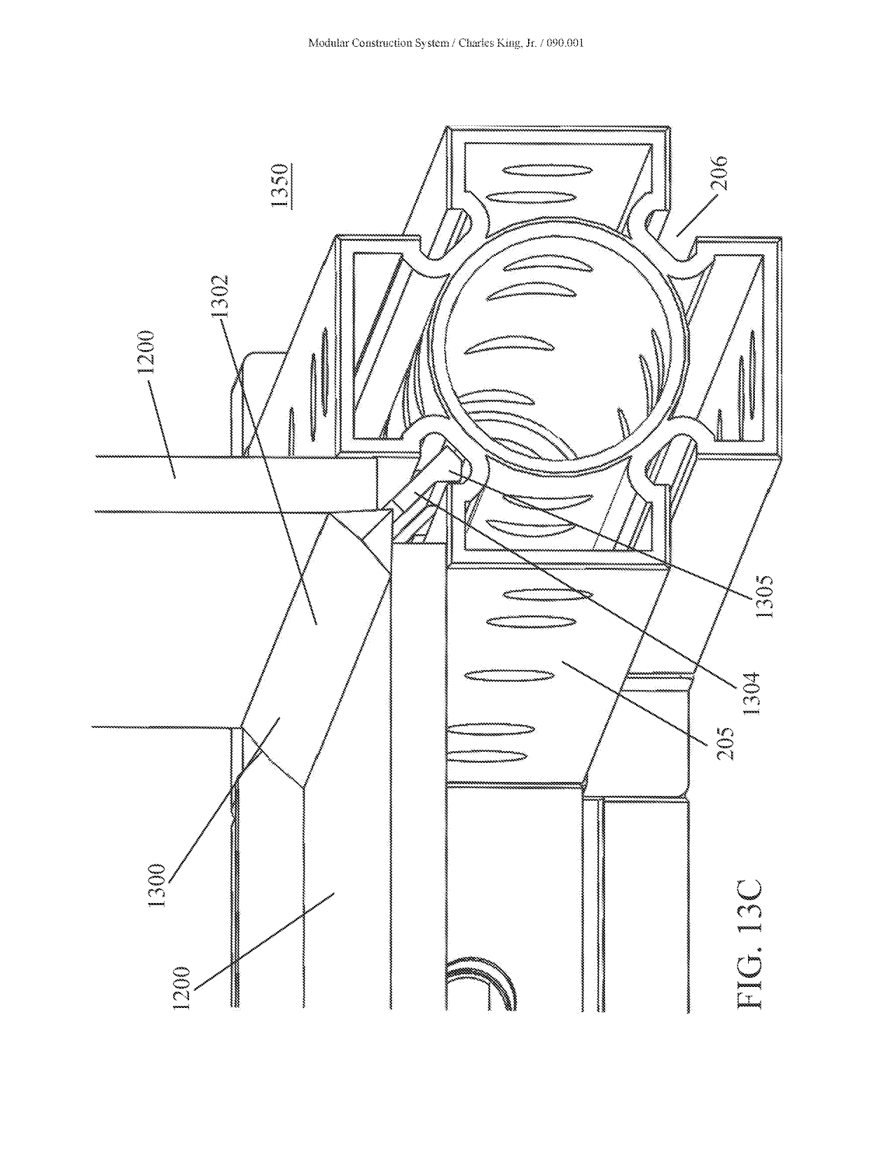

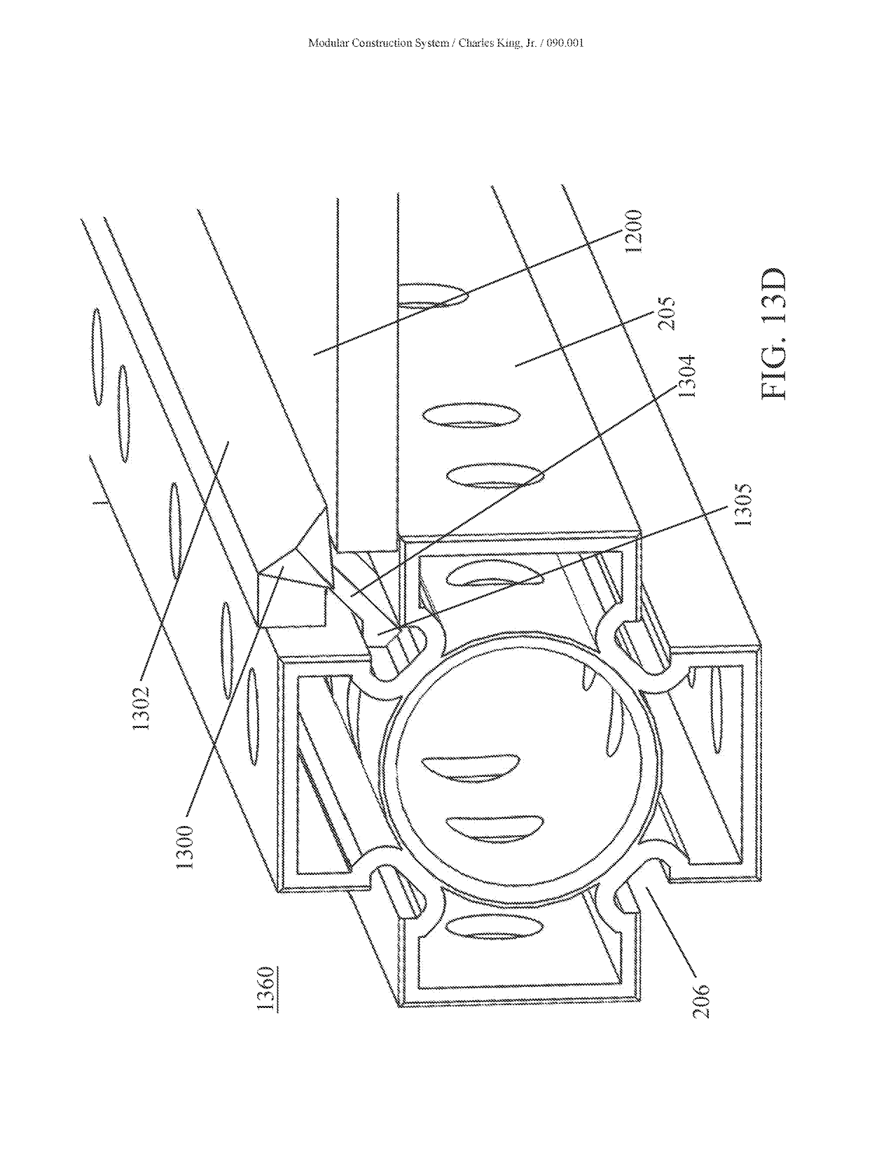

FIG. 13 is a perspective view of an embodiment of the inside snap spline 1300. The inside snap spline 1300 comprises a first inside snap end 1301, an inside snap body 1302, a second inside snap end 1303, and a plurality of integrally formed inside snap tabs 1304. The inside snap tabs 1304 extend from the inside snap body 1302. Each of the inside snap tabs 1304 comprises an inside snap ridge 1305. The inside snap ridge 1305 extends from the inside snap tab 1304. The inside snap ends 1303 are adapted to be fitted into the notch 104 of the main connector 100. The inside snap tabs 1304 are adapted to be releasably engaged to the main bar grooves 206. The inside snap tabs 1304 are adapted to be releasably engaged to the inside bar hanger grooves 415, 435. Preferably, the inside snap ridges 1305 alternate in orientation to allow the inside snap tabs 1304 to be more securely engaged to the main bar grooves 206 and the inside bar hanger grooves 415, 435. FIG. 13 shows two inside snap splines 1300 with different inside snap bodies 1302 having different cross-section geometries. The inside snap spline 1300 may be fabricated to match different uses, such as for assembled structures with different number of panels 1200, or to match different geometries and sizes of the notches 104 of the main connector 100, the main bar longitudinal sides 205, the inside bar hanger longitudinal sides 414, 434 and panels 1200. The inside snap spline 1300 may be fabricated to suit variety of aesthetic reasons.

Two different embodiments of the present invention are depicted as structures 1350 and 1360, where inside snap splines 1300 are utilized to secure a panel 1200 to an assembled structure. Structure 1350 depicts the application of an inside snap spline 1300 with two panels 1200, one vertical and one horizontal. Structure 1360 depicts the application of an inside snap spline 1300 with one panel 1200 that is horizontally oriented. Alternatively, the inside snap splice 1300 may be utilized without panels 1200 for aesthetic and functional reasons, for instance, to cover the main bar grooves 206 and the inside bar hanger grooves 415, 435 for a finished look and to prevent objects from entering the main bar grooves 206 and the inside bar hanger grooves 415, 435. The two inside snap splines 1300 have different inside snap body 1302 geometries because each inside snap spline 1300 is fabricated to be fitted with different uses, in this case utilizing different number of panels 1200. Although the two inside snap splines 1300 have different inside snap body 1302 geometries, the are assembled in the same manner: a panel 1200 is placed against a main bar longitudinal side 205, then the inside snap spline 1300 is pressed into the main bar groove 206, where the inside snap tabs 1304 are releasably engaged to the main bar groove 206.

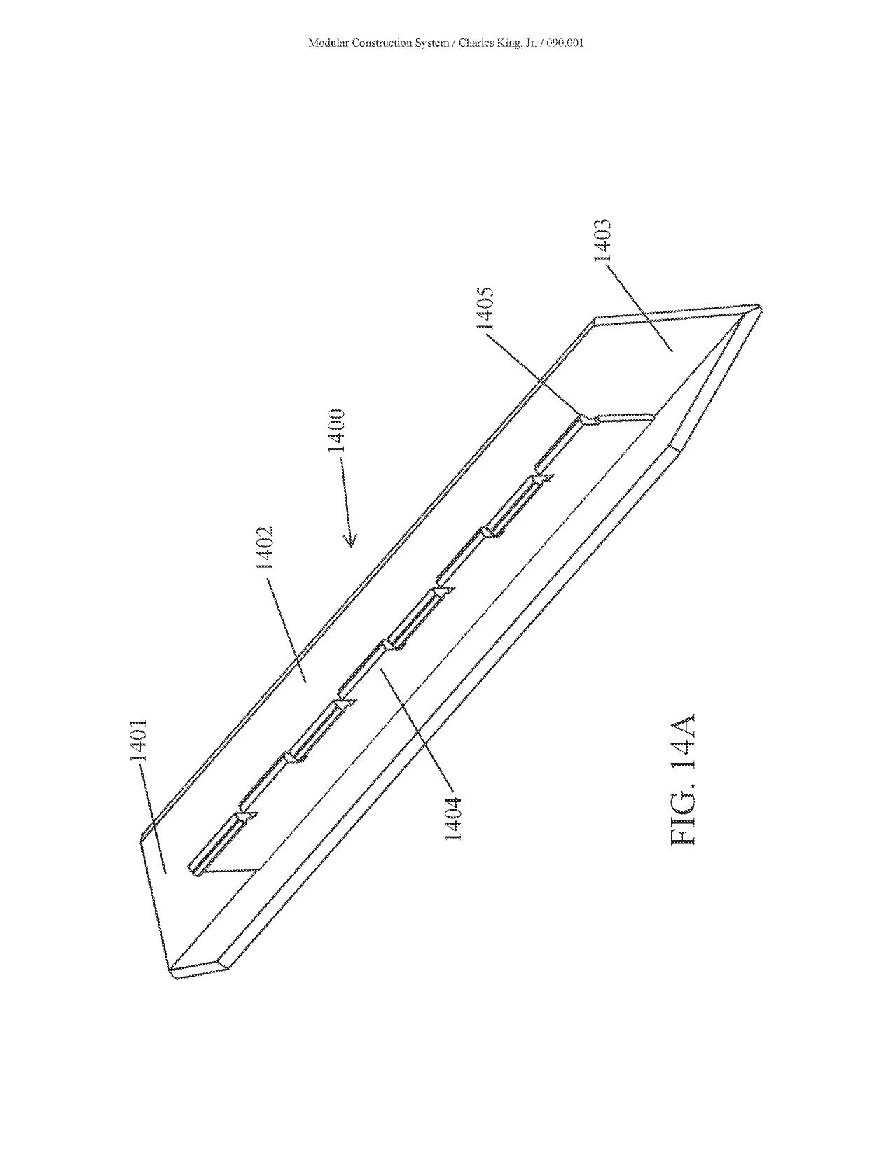

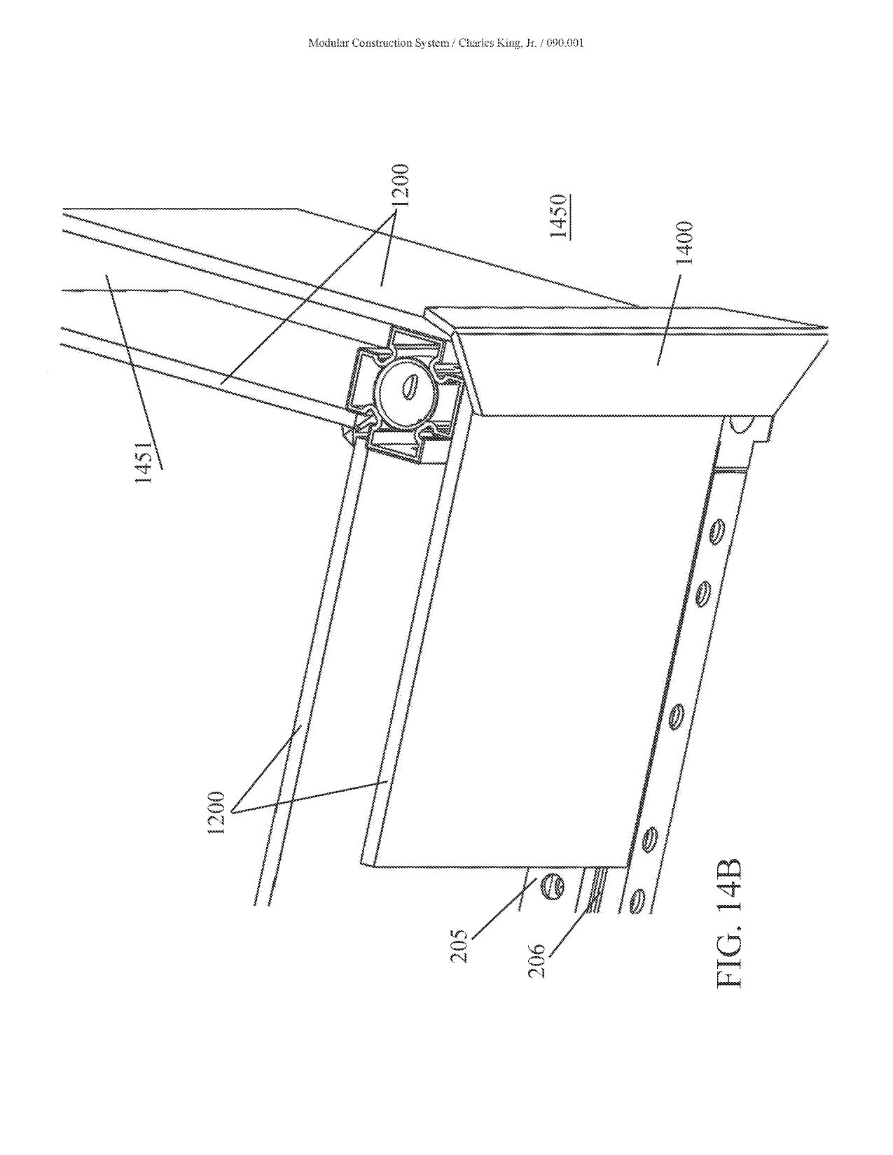

FIG. 14 is a perspective view of an embodiment of the outside snap spline 1400. The outside snap spline 1400 comprises a first outside snap end 1401, an outside snap body 1402, a second outside snap end 1403, and a plurality of integrally formed outside snap tabs 1404. The outside snap tabs 1404 extend from the outside snap body 1402. Each of the outside snap tabs 1404 comprises an outside snap ridge 1405. The outside snap ridge 1405 extends from the outside snap tab 1404. The outside snap ends 1403 are adapted to be fitted over the notch 104 of the main connector 100. The outside snap tabs 1404 are adapted to be releasably engaged to the main bar grooves 206. The outside snap tabs 1404 are adapted to be releasably engaged to the inside bar hanger grooves 415, 435. Preferably, the outside snap ridges 1405 alternate in orientation to allow the outside snap tabs 1404 to be more securely engaged to the main bar grooves 206 and the inside bar hanger grooves 415, 435. The outside snap spline 1400 may be fabricated to match different uses, such as for assembled structures with different number of panels 1200, or to cover different geometries and sizes of the notches 104 of the main connector 100, the main bar longitudinal sides 205, the inside bar hanger longitudinal sides 414, 434 and panels 1200. The outside snap spline 1400 may be fabricated to suit variety of aesthetic reasons.

An embodiment of the present invention is depicted as structure 1450, where the outside snap spline 1400 is utilized to secure two panels 1200 to an assembled structure. The other two panels are secured by inside snap splines 1300, which are not shown. Like the inside snap splines 1300 depicted in structures 1350 and 1360, the outside snap spline 1400 is utilized in a similar manner: a panel 1200 is placed against a main bar longitudinal side 205, then the outside snap spline 1400 is pressed into the main bar groove 206, where the outside snap tabs 1404 are releasably engaged to the main bar groove 206. Alternatively, the outside snap splice 1400 may be utilized without panels 1200 for aesthetic and functional reasons, for instance, to cover the main bar grooves 206 and the inside bar hanger grooves 415, 435 for a finished look and to prevent objects from entering the main bar grooves 206 and the inside bar hanger grooves 415, 435. Structures that utilize inside snap splines 1300 and outside snap splines 1400 to secure a plurality of panels 1200, for example structure 1450, create a cavity 1451 between interior and exterior panels 1200. The cavity 1451 may be utilized for holding insulation, electrical components, plumbing components or other materials. Furthermore, panels 1200 may have openings (not shown) to facilitate passage of the materials.

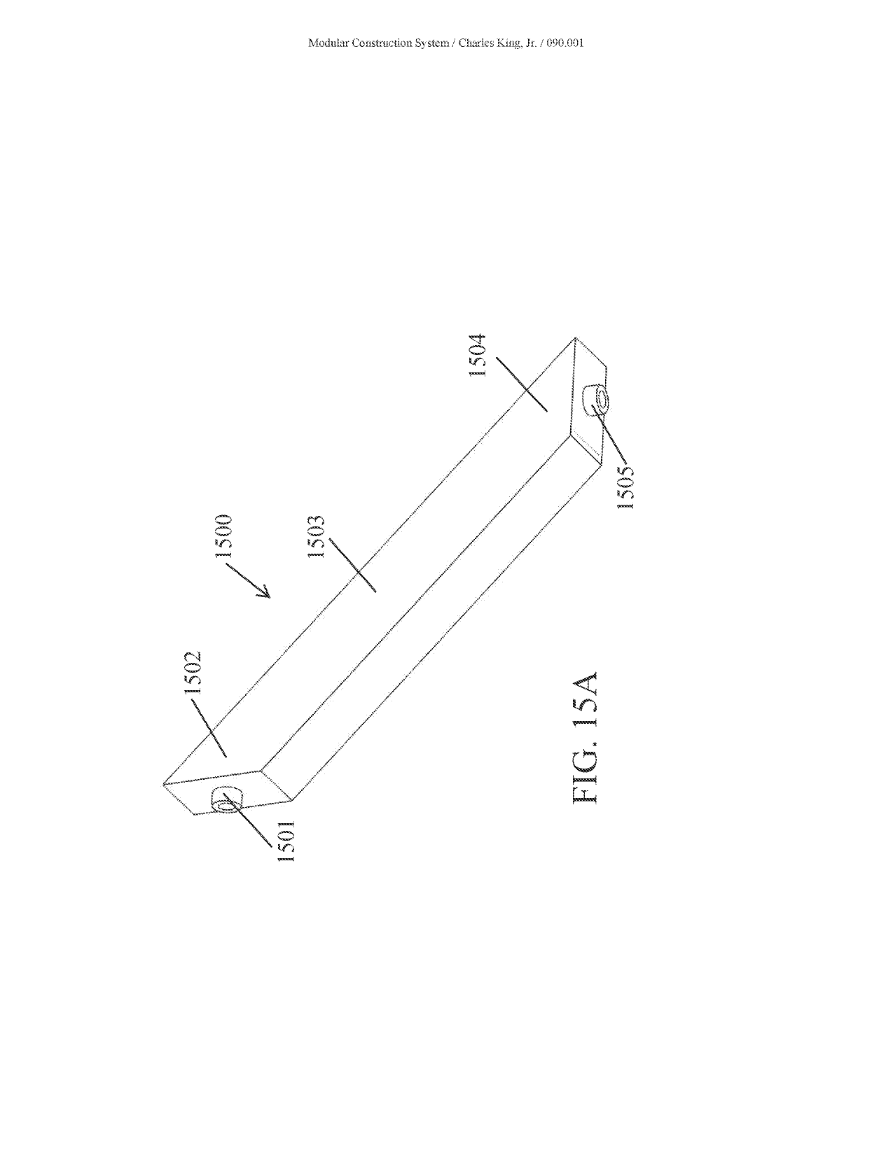

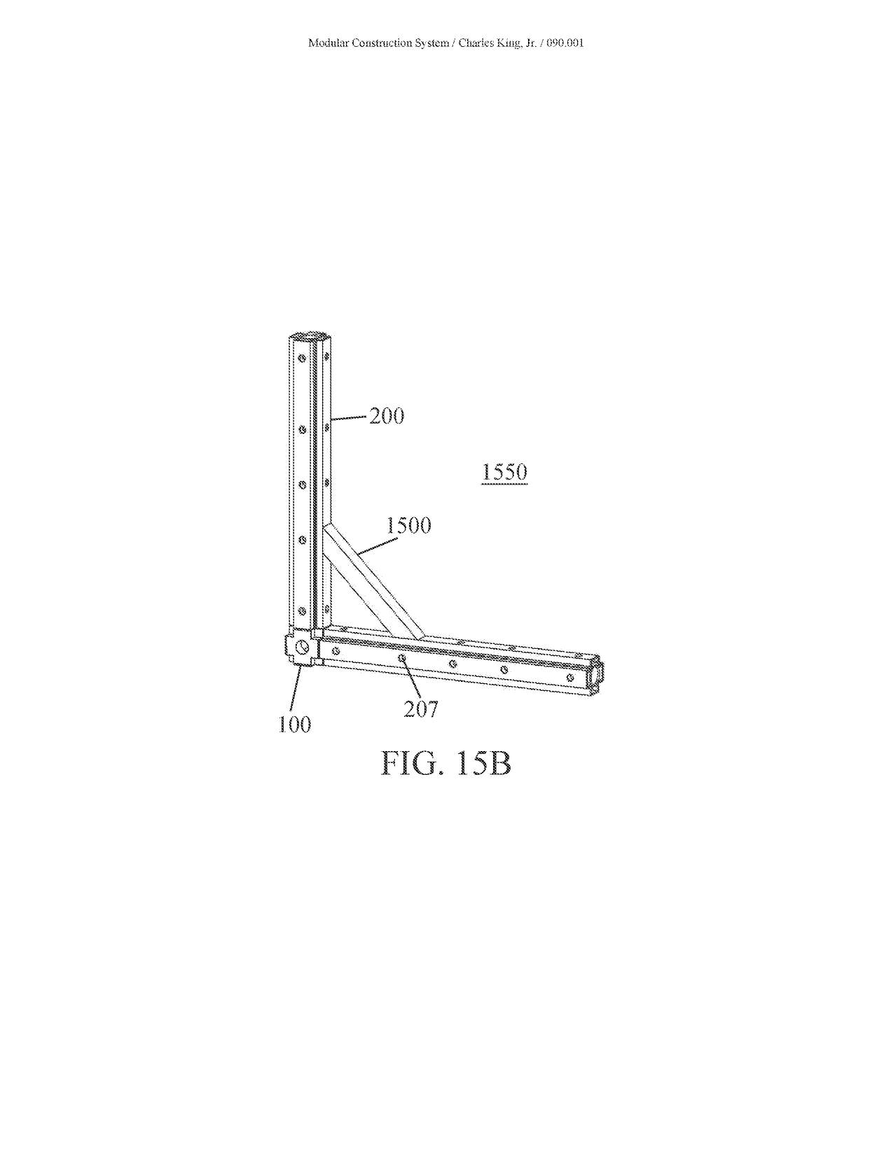

FIG. 15 is a perspective view of an embodiment of corner bar brace 1500. The corner bar brace 1500 comprises a first corner bar brace insertion pin 1501, a first corner bar brace end 1502, a corner bar brace body 1503, a second corner bar brace end 1504, and a second corner bar brace insertion pin 1505, wherein the first corner bar brace insertion pin 1501 extends from the first corner bar brace end 1502 and the second corner bar brace insertion pin 1505 extends from the second corner bar brace end 1504.

An embodiment of the present invention is depicted in structure 1550, where a corner bar brace 1500 is providing support to structure 1550. The corner bar brace insertion pins 1501, 1505 are releasably engaged in one aperture 207 of each of the main bars 200. Preferably, the corner bar brace insertion pins 1501, 1505 are spring loaded, which allows the insertion of the corner bar brace 1500 after the other components of structure 1550 are already assembled. Utilization of the corner bar brace 1500 serves to strengthen the structure 1550. The corner bar brace ends 1502, 1504 may be fabricated with different angles to adapted to various configurations. Structure 1550 depicts the two main bars 200 as having a ninety degree angle between the two main bars 200. The angle may be different if the ball and socket connector 600 or the flexible angle corner connector 700 is utilized.

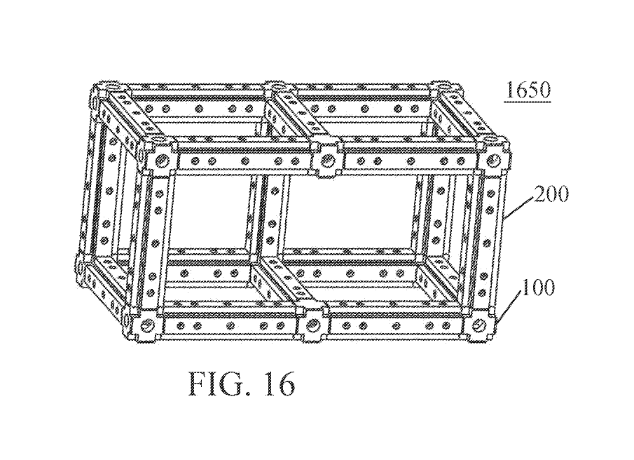

FIG. 16 is a perspective view of an assembled embodiment present invention. Structure 1650 depicts a structure assembled with a plurality of main connectors 100, rods 101, and main bars 200. As can be discerned from structure 1650, in an assembled structure, if all rods 101 are utilized, then the rods 101 are not visible.

In an embodiment of the present invention, the body 102 comprises six faces 106, eight vertices 105 and eight notches 104 on the eight vertices 105, examples of which are found in structures 150 and 160.

In an embodiment of the present invention, the main bar 200 comprises four main bar longitudinal sides 205, an example of which is found in structure 250.

In an embodiment of the present invention, the main connector 100 is made of material that includes Acrylonitrile Butadiene Styrene (ABS) plastic.

In an embodiment of the present invention, the rod 101 is made of material that includes ABS plastic.

In an embodiment of the present invention, the main bar 200 is made of material that includes ABS plastic.

In an embodiment of the present invention, the reinforcement rod 300 is made of material that includes ABS plastic.

In an embodiment of the present invention, the inside bar hanger connector 400 is made of material that includes ABS plastic.

In an embodiment of the present invention, the main bar splice 500 is made of material that includes ABS plastic.

In an embodiment of the present invention, the ball and socket connector 600 is made of material that includes ABS plastic.

In an embodiment of the present invention, the flexible angle corner connector 700 is made of material that includes ABS plastic.

In an embodiment of the present invention, the outside angle bar hanger connector 800 is made of material that includes ABS plastic.

In an embodiment of the present invention, the angled low profile bar 900 is made of material that includes ABS plastic.

In an embodiment of the present invention, the flat low profile bar 1000 is made of material that includes ABS plastic.

In an embodiment of the present invention, the cross bar 1100 is made of material that includes ABS plastic.

In an embodiment of the present invention, the cross bar connector 1110 is made of material that includes ABS plastic.

In an embodiment of the present invention, the panel 1200 is made of material that includes ABS plastic.

In an embodiment of the present invention, the inside snap spline 1300 is made of material that includes ABS plastic.

In an embodiment of the present invention, the outside snap spline 1400 is made of material that includes ABS plastic.

In an embodiment of the present invention, the corner bar brace 1500 is made of material that includes ABS plastic.

I claim:

1. A modular construction system, comprising:
a main connector having a body and an integrally formed rod, the rod having a rod tubular body, a rod insertion end, and a rod hollow chamber traversing the rod from the rod tubular body through the rod insertion end, and wherein the rod is radially disposed about the body;
a plurality of main bars, each of the main bars having a first receiving end, a main bar tubular body, a second receiving end, a main bar hollow chamber traversing the main bar from the first receiving end through the main bar tubular body to the second receiving end, at least three main bar longitudinal sides, a plurality of apertures on the main bar longitudinal sides, and at least three main bar grooves between adjacent main bar longitudinal sides, and the main bar grooves being parallel with the main bar tubular body and the main bar hollow chamber; and, wherein the rod insertion end being adapted to be fitted into the receiving ends.

2. The modular construction system of claim 1, wherein the body comprises at least four faces and at least four vertices, wherein the rod extends from one of the faces, wherein the rod insertion end comprises a rod resilient locking pin, the receiving ends comprise a plurality of main bar pin locking openings, and wherein the rod resilient locking pin is adapted to be releasably engaged to each of the main bar pin locking openings.

3. The modular construction system of claim 2, wherein each of the main bar longitudinal sides has a T-shaped cross section.

4. The modular construction system of claim 3, further comprising:
a reinforcement rod that is adapted to be fitted within the main bar hollow chamber and is adapted to be fitted within the rod hollow chamber;
an inside bar hanger connector comprising:
a first inside bar hanger section having a first inside bar hanger end, a first inside bar hanger tubular body, a first inside bar hanger hollow chamber traversing the first inside bar hanger end through the first inside bar hanger tubular body, at least three first inside bar hanger longitudinal sides, and at least three first inside bar hanger grooves between adjacent first inside bar hanger longitudinal sides, the first inside bar hanger grooves being parallel with the first inside bar hanger tubular body and the first inside bar hanger hollow chamber, wherein the first inside bar hanger end comprises a plurality of first inside bar hanger pin locking openings, and wherein each of the first inside bar hanger longitudinal sides has a T-shaped cross section;
a inside bar hanger joint; and,
a second inside bar hanger section having a second inside bar hanger end, a second inside bar hanger tubular body, a second inside bar hanger hollow chamber traversing the second inside bar hanger end through the second inside bar hanger tubular body, at least three second inside bar hanger longitudinal sides, and at least three second inside bar hanger grooves between adjacent second inside bar hanger longitudinal sides, the second inside bar hanger grooves being parallel with the second inside bar hanger tubular body and the second inside bar hanger hollow chamber, wherein the second inside bar hanger end comprises a plurality of second inside bar hanger pin locking openings, and wherein each of the second inside bar hanger longitudinal sides has a T-shaped cross section;
wherein the rod resilient locking pins are adapted to be releasably engaged to each of the inside bar hanger pin openings, wherein the inside bar hanger joint is adapted to allow the first inside bar hanger section to flex in relation to the second inside bar hanger section, and wherein the reinforcement rod is adapted to be fitted within the inside bar hanger hollow chambers.
a main bar splice having a first splice end, a splice tubular body, a second splice end, and a splice hollow chamber traversing the main bar splice from the first splice end through the splice tubular body to the second splice end, wherein the splice ends comprise a plurality of splice resilient locking pins, wherein each of the splice resilient locking pins are adapted to be releasably engaged to each of the main bar pin locking openings, wherein each of the splice resilient locking pins are adapted to be releasably engaged to each of the inside bar hanger pin locking openings, and wherein the reinforcement rod is adapted to be fitted within the splice hollow chamber;
a ball and socket connector comprising:
a first ball and socket section having first ball and socket end, a first ball and socket tubular body, and a first ball and socket hollow chamber traversing the first ball and socket end through the first ball and socket tubular body;
a ball and socket joint; and,
a second ball and socket section having a second ball and socket end, a second ball and socket tubular body, and a second ball and socket hollow chamber traversing the second ball and socket end through the second ball and socket tubular body;
wherein the ball and socket ends comprise a plurality of ball and socket resilient locking pins, wherein each of the ball and socket resilient locking pins are adapted to be releasably engaged to each of the main bar pin locking openings, wherein each of the ball and socket resilient locking pins are adapted to be releasably engaged to each of the inside bar hanger pin locking openings, wherein the ball and socket joint is adapted to allow the first ball and socket section to rotate in relation to the second ball and socket section, and wherein the reinforcement rod is adapted to be fitted within the ball and socket hollow chambers; and,
a flexible angle corner connector comprising:
a first flexible angle corner section having a first flexible angle corner end, a first flexible angle corner tubular body, and a first flexible angle corner hollow chamber traversing the first flexible angle corner end through the first flexible angle corner tubular body;
a flexible angle corner joint; and,
a second flexible angle corner section having a second flexible angle corner end, a second flexible angle corner tubular body, and a second flexible angle corner hollow chamber traversing the second flexible angle corner end through the second flexible angle corner tubular body;
wherein the flexible angle corner ends comprise a plurality of flexible angle corner resilient locking pins, wherein each of the flexible angle corner resilient locking pins are adapted to be releasably engaged to each of the main bar pin locking openings, wherein each of the flexible angle corner resilient locking pins are adapted to be releasably engaged to each of the inside bar hanger pin locking openings, wherein the flexible angle corner joint is adapted to allow the first flexible angle corner section to flex in relation to the second flexible angle corner section, and wherein the reinforcement rod is adapted to be fitted within the flexible angle corner hollow chambers.

5. The modular construction system of claim 3, wherein the body further comprises a hole on one of the faces; the modular construction system further comprising:
an outside angle bar hanger connector having a plate and a plurality of outside angle bar hanger insertion pins, and wherein the outside angle bar hanger insertion pins are adapted to be releasably engaged to the hole;
an angled low profile bar having an angled low profile bar body, a plurality of upright extensions, and a plurality of angled low profile bar insertion pins, wherein the angled low profile bar body is adapted to have a predetermined angle to the upright extensions, and wherein the angled low profile bar insertion pins are adapted to be releasably engaged to the hole;
a flat low profile bar having a flat low profile bar body and a plurality of flat low profile bar insertion pins, wherein the flat low profile bar insertion pins are adapted to be releasably engaged to the hole;
a cross bar having a first cross bar opening, a first cross bar end, a cross bar body, a second cross bar end, and a second cross bar opening;
a cross bar connector having a cross bar connector insertion pin, a flange, and cross bar insertion end, wherein the cross bar insertion end is adapted to be releasably engaged to the cross bar openings, and wherein the cross bar connector insertion pin is adapted to be releasably engaged to each of the apertures; and,
a corner bar brace having a first corner bar brace insertion pin, a first corner bar brace end, a corner bar brace body, a second corner bar brace end, and a second corner bar brace insertion pin, wherein the first corner bar brace insertion pin and the second corner bar brace insertion pin are adapted to be releasably engaged to each of the apertures.

6. The modular construction system of claim 3, wherein the body further comprises a notch on one of the vertices; the modular construction system further comprising:
a panel;
an inside snap spline having a first inside snap end, an inside snap body, a second inside snap end, and a plurality of integrally formed inside snap tabs, wherein the inside snap tabs extend from the inside snap body, wherein the inside snap ends are adapted to be fitted into the notch, wherein the inside snap tabs are adapted to be releasably engaged to the main bar grooves, and wherein the inside snap tabs are adapted to be releasably engaged to the inside bar hanger grooves; and,
an outside snap spline having a first outside snap end, an outside snap body, a second outside snap end, and a plurality of integrally formed outside snap tabs, wherein the outside snap tabs extend from the outside snap body, wherein the outside snap ends are adapted to be fitted into the notch, wherein the outside snap tabs are adapted to be releasably engaged to the main bar grooves, and wherein the outside snap tabs are adapted to be releasably engaged to the inside bar hanger grooves.

7. The modular construction system of claim 3, wherein the rod resilient locking pin comprises a chamfered rod insertion side, a chamfered rod left side, a chamfered rod right side, and a non-chamfered rod side; each of the splice resilient locking pins comprises a chamfered splice insertion side, a chamfered splice left side, a chamfered splice right side, and a non-chamfered splice side; each of the ball and socket resilient locking pins comprises a chamfered ball and socket insertion side, a chamfered ball and socket left side, a chamfered ball and socket right side, and a non-chamfered ball and socket side; and, each of the flexible angle corner resilient locking pins comprises a chamfered flexible angle corner insertion side, a chamfered flexible angle corner left side, a chamfered flexible angle corner right side, and a non-chamfered flexible angle corner side.

8. The modular construction system of claim 7, wherein the body has six faces, eight vertices and eight notches on the eight vertices.

9. The modular construction system of claim 8, wherein each of the main bars have four main bar longitudinal sides.

10. The modular construction system of claim 9, wherein:
the main connector is made of material that includes ABS plastic;
the main bar is made of material that includes ABS plastic;
the reinforcement rod is made of material that includes ABS plastic;
the inside bar hanger connector is made of material that includes ABS plastic;
the main bar splice is made of material that includes ABS plastic;
the ball and socket connector is made of material that includes ABS plastic;
the flexible angle corner connector is made of material that includes ABS plastic;
the outside angle bar hanger connector is made of material that includes ABS plastic;
the angled low profile bar is made of material that includes ABS plastic;
the flat low profile bar is made of material that includes ABS plastic;
the cross bar is made of material that includes ABS plastic;
the cross bar connector is made of material that includes ABS plastic;
the panel is made of material that includes ABS plastic;
the inside snap spline is made of material that includes ABS plastic;
the outside snap spline is made of material that includes ABS plastic; and,
the corner bar brace is made of material that includes ABS plastic.

11. A modular construction system, comprising:
a main connector having a body and a hole, wherein the hole is radially disposed about the body;
a rod having a rod main connector end, a rod tubular body, a rod insertion end, and a rod hollow chamber traversing the rod from the rod main connector end through the rod tubular body and through the rod insertion end, and wherein the rod main connector end is releasably engaged to the hole; and,
a plurality of main bars, each of the main bars having a first receiving end, a main bar tubular body, a second receiving end, a main bar hollow chamber traversing the main bar from the first receiving end through the main bar tubular body to the second receiving end, at least three main bar longitudinal sides, a plurality of apertures on the main bar longitudinal sides, and at least three main bar grooves between adjacent main bar longitudinal sides, and the main bar grooves being parallel with the main bar tubular body and the main bar hollow chamber; and, wherein the rod insertion end being adapted to be fitted into the receiving ends.

12. The modular construction system of claim 11, wherein the body comprises at least four faces and at least four vertices, wherein the hole comprises a receiving slot and a locking slot, wherein the rod main connector end comprises a nub, wherein the nub is adapted to be releasably engaged to the receiving slot and the locking slot, wherein the rod insertion end comprises a rod resilient locking pin, the receiving ends comprise a plurality of main bar pin locking openings, and wherein the rod resilient locking pin is adapted to be releasably engaged to each of the main bar pin locking openings.

13. The modular construction system of claim 12, wherein each of the main bar longitudinal sides has a T-shaped cross section.

14. The modular construction system of claim 13, further comprising:
a reinforcement rod that is adapted to be fitted within the main bar hollow chamber and is adapted to be fitted within the rod hollow chamber;
an inside bar hanger connector comprising:
a first inside bar hanger section having a first inside bar hanger end, a first inside bar hanger tubular body, a first inside bar hanger hollow chamber traversing the first inside bar hanger end through the first inside bar hanger tubular body, at least three first inside bar hanger longitudinal sides, and at least three first inside bar hanger grooves between adjacent first inside bar hanger longitudinal sides, the first inside bar hanger grooves being parallel with the first inside bar hanger tubular body and the first inside bar hanger hollow chamber, wherein the first inside bar hanger end comprises a plurality of first inside bar hanger pin locking openings, and wherein each of the first inside bar hanger longitudinal sides has a T-shaped cross section;
a inside bar hanger joint; and,
a second inside bar hanger section having a second inside bar hanger end, a second inside bar hanger tubular body, a second inside bar hanger hollow chamber traversing the second inside bar hanger end through the second inside bar hanger tubular body, at least three second inside bar hanger longitudinal sides, and at least three second inside bar hanger grooves between adjacent second inside bar hanger longitudinal sides, the second inside bar hanger grooves being parallel with the second inside bar hanger tubular body and the second inside bar hanger hollow chamber, wherein the second inside bar hanger end comprises a plurality of second inside bar hanger pin locking openings, and wherein each of the second inside bar hanger longitudinal sides has a T-shaped cross section;
wherein the rod resilient locking pins are adapted to be releasably engaged to each of the inside bar hanger pin openings, wherein the inside bar hanger joint is adapted to allow the first inside bar hanger section to flex in relation to the second inside bar hanger section, and wherein the reinforcement rod is adapted to be fitted within the inside bar hanger hollow chambers.
a main bar splice having a first splice end, a splice tubular body, a second splice end, and a splice hollow chamber traversing the main bar splice from the first splice end through the splice tubular body to the second splice end, wherein the splice ends comprise a plurality of splice resilient locking pins, wherein each of the splice resilient locking pins are adapted to be releasably engaged to each of the main bar pin locking openings, wherein each of the splice resilient locking pins are adapted to be releasably engaged to each of the inside bar hanger pin locking openings, and wherein the reinforcement rod is adapted to be fitted within the splice hollow chamber;
a ball and socket connector comprising:
a first ball and socket section having first ball and socket end, a first ball and socket tubular body, and a first ball and socket hollow chamber traversing the first ball and socket end through the first ball and socket tubular body;
a ball and socket joint; and,
a second ball and socket section having a second ball and socket end, a second ball and socket tubular body, and a second ball and socket hollow chamber traversing the second ball and socket end through the second ball and socket tubular body;
wherein the ball and socket ends comprise a plurality of ball and socket resilient locking pins, wherein each of the ball and socket resilient locking pins are adapted to be releasably engaged to each of the main bar pin locking openings, wherein each of the ball and socket resilient locking pins are adapted to be releasably engaged to each of the inside bar hanger pin locking openings, wherein the ball and socket joint is adapted to allow the first ball and socket section to rotate in relation to the second ball and socket section, and wherein the reinforcement rod is adapted to be fitted within the ball and socket hollow chambers; and,
a flexible angle corner connector comprising:
a first flexible angle corner section having a first flexible angle corner end, a first flexible angle corner tubular body, and a first flexible angle corner hollow chamber traversing the first flexible angle corner end through the first flexible angle corner tubular body;
a flexible angle corner joint; and,
a second flexible angle corner section having a second flexible angle corner end, a second flexible angle corner tubular body, and a second flexible angle corner hollow chamber traversing the second flexible angle corner end through the second flexible angle corner tubular body;
wherein the flexible angle corner ends comprise a plurality of flexible angle corner resilient locking pins, wherein each of the flexible angle corner resilient locking pins are adapted to be releasably engaged to each of the main bar pin locking openings, wherein each of the flexible angle corner resilient locking pins are adapted to be releasably engaged to each of the inside bar hanger pin locking openings, wherein the flexible angle corner joint is adapted to allow the first flexible angle corner section to flex in relation to the second flexible angle corner section, and wherein the reinforcement rod is adapted to be fitted within the flexible angle corner hollow chambers.

15. The modular construction system of claim 13, wherein the hole is on one of the faces; the modular construction system further comprising:
an outside angle bar hanger connector having a plate and a plurality of outside angle bar hanger insertion pins, and wherein the outside angle bar hanger insertion pins are adapted to be releasably engaged to the hole;
an angled low profile bar having an angled low profile bar body, a plurality of upright extensions, and a plurality of angled low profile bar insertion pins, wherein the angled low profile bar body is adapted to have a predetermined angle to the upright extensions, and wherein the angled low profile bar insertion pins are adapted to be releasably engaged to the hole;
a flat low profile bar having a flat low profile bar body and a plurality of flat low profile bar insertion pins, wherein the flat low profile bar insertion pins are adapted to be releasably engaged to the hole;
a cross bar having a first cross bar opening, a first cross bar end, a cross bar body, a second cross bar end, and a second cross bar opening;
a cross bar connector having a cross bar connector insertion pin, a flange, and cross bar insertion end, wherein the cross bar insertion end is adapted to be releasably engaged to the cross bar openings, and wherein the cross bar connector insertion pin is adapted to be releasably engaged to each of the apertures; and,
a corner bar brace having a first corner bar brace insertion pin, a first corner bar brace end, a corner bar brace body, a second corner bar brace end, and a second corner bar brace insertion pin, wherein the first corner bar brace insertion pin and the second corner bar brace insertion pin are adapted to be releasably engaged to each of the apertures.

16. The modular construction system of claim 13, wherein the body further comprises a notch on one of the vertices; the modular construction system further comprising:
a panel;
an inside snap spline having a first inside snap end, an inside snap body, a second inside snap end, and a plurality of integrally formed inside snap tabs, wherein the inside snap tabs extend from the inside snap body, wherein the inside snap ends are adapted to be fitted into the notch, wherein the inside snap tabs are adapted to be releasably engaged to the main bar grooves, and wherein the inside snap tabs are adapted to be releasably engaged to the inside bar hanger grooves; and,
an outside snap spline having a first outside snap end, an outside snap body, a second outside snap end, and a plurality of integrally formed outside snap tabs, wherein the outside snap tabs extend from the outside snap body, wherein the outside snap ends are adapted to be fitted into the notch, wherein the outside snap tabs are adapted to be releasably engaged to the main bar grooves, and wherein the outside snap tabs are adapted to be releasably engaged to the inside bar hanger grooves.

17. The modular construction system of claim 13, wherein the rod resilient locking pin comprises a chamfered rod insertion side, a chamfered rod left side, a chamfered rod right side, and a non-chamfered rod side; each of the splice resilient locking pins comprises a chamfered splice insertion side, a chamfered splice left side, a chamfered splice right side, and a non-chamfered splice side; each of the ball and socket resilient locking pins comprises a chamfered ball and socket insertion side, a chamfered ball and socket left side, a chamfered ball and socket right side, and a non-chamfered ball and socket side; and, each of the flexible angle corner resilient locking pins comprises a chamfered flexible angle corner insertion side, a chamfered flexible angle corner left side, a chamfered flexible angle corner right side, and a non-chamfered flexible angle corner side.

18. The modular construction system of claim 17, wherein the body has six faces, eight vertices and eight notches on the eight vertices.

19. The modular construction system of claim 18, wherein each of the main bars have four main bar longitudinal sides.

20. The modular construction system of claim 19, wherein:
the main connector is made of material that includes ABS plastic;
the rod is made of material that includes ABS plastic;
the main bar is made of material that includes ABS plastic;
the reinforcement rod is made of material that includes ABS plastic;
the inside bar hanger connector is made of material that includes ABS plastic;
the main bar splice is made of material that includes ABS plastic;
the ball and socket connector is made of material that includes ABS plastic;
the flexible angle corner connector is made of material that includes ABS plastic;
the outside angle bar hanger connector is made of material that includes ABS plastic;
the angled low profile bar is made of material that includes ABS plastic;
the flat low profile bar is made of material that includes ABS plastic;
the cross bar is made of material that includes ABS plastic;
the cross bar connector is made of material that includes ABS plastic;
the panel is made of material that includes ABS plastic;
the inside snap spline is made of material that includes ABS plastic;
the outside snap spline is made of material that includes ABS plastic; and,
the corner bar brace is made of material that includes ABS plastic.
